(19) United States
(12) Patent Application Publication
(10) Pub. No.: US 2024/0327246 A1
(43) Pub. Date: Oct. 3, 2024

(54) SYSTEM AND METHOD FOR MONITORING PERFORMANCE OF MEMBRANES IN REVERSE OSMOSIS (RO) SYSTEM

(71) Applicant: ACWA POWER Company, Riyadh (SA)

(72) Inventor: Sérgio Miguel Alegria CASIMIRO, Dubai (AE)

(73) Assignee: ACWA POWER Company, Riyadh (SA)

(21) Appl. No.: 18/623,436

(22) Filed: Apr. 1, 2024

Related U.S. Application Data
(60) Provisional application No. 63/493,986, filed on Apr. 3, 2023.

(51) Int. Cl. C02F 1/00; C02F 1/44

(52) U.S. Cl. CPC C02F 1/008; C02F 1/441; C02F 2209/02; C02F 2209/05; C02F 2209/06; C02F 2209/40

(57) ABSTRACT

A control system and a reverse osmosis (RO) system for monitoring membrane performance of reverse osmosis systems controls a first movement of a separator from an initial position to a first position within a permeate tube of the RO system based upon a determination of at least one trigger point from a set of trigger points. The control system and/or the RO system determine a first flowrate of a permeate flowing through a first membrane of a set of membranes of the RO system based upon the first movement of the separator. The control system and/or the RO system calculates a first flux for the first membrane based upon the determined first flowrate and a first surface area of the first membrane. The control system and/or the RO system also displays the calculated first flux on a display screen.

### CROSS-REFERENCE TO RELATED APPLICATIONS

This application claims priority to U.S. Provisional Patent Application Ser. No. 63/493,986, filed Apr. 3, 2023, and entitled “SYSTEM AND METHOD FOR MEMBRANE PERFORMANCE MONITORING ON WORKING TRAINS IN DESALINATION PLANTS”, the disclosure of which is incorporated herein by reference.

### TECHNOLOGICAL FIELD

The present disclosure generally relates to reverse osmosis (RO) systems, and more particularly relates to monitoring the performance of membranes in RO systems.

### BACKGROUND

Reverse Osmosis (RO) is a process for water purification, especially in areas where freshwater is scarce. The process of RO is usually done in a RO system. In recent years, seawater reverse osmosis (SWRO) and brackish water reverse osmosis (BWRO) have emerged as effective solutions for providing potable water in coastal regions, islands, and arid countries. The process of SWRO involves passing seawater through at least one semi-permeable membrane under high pressure that separates the salt and other impurities from the seawater, thereby producing freshwater whereas the process of BWRO involves passing saline or brackish water through at least one semi-permeable membrane under high pressure that separates the salt and other impurities from the saline or brackish water. SWRO plant and/or BWRO plant (also collectively referred to as ‘RO plants’ or ‘RO systems’) include different components such as pumps, semi-permeable membranes, separators, flowmeters, energy recovery devices, and the like. With time, such components may incur several problems that lower a production capacity of the RO plant.

Typically, the RO system includes at least one semi-permeable membrane that may be utilized for desalination using reverse osmosis. Desalination is the process of removing salt and other minerals from seawater or brackish water to make it suitable for drinking or irrigation. As discussed above, the semi-permeable membranes may incur problems such as scaling and fouling with time. Scaling may refer to a buildup of mineral deposits, such as calcium carbonate, on surfaces of the semi-permeable membranes whereas fouling refers to an accumulation of particles or organic substances on surfaces of the semi-permeable membranes. Both scaling and fouling may significantly decrease the performance and lifespan of the semi-permeable membranes which may lower the production capacity of the RO system.

Therefore, there may be a need for a system required to assess the performance of the membranes of the RO system.

### BRIEF SUMMARY

A control system, a reverse osmosis (RO) system, and a method are provided herein that focuses on monitoring the performance of each membrane in the RO system. The RO system may be a type of water filtration system that uses the semi-permeable membranes to remove impurities, contaminants, and particles from feedwater (such as seawater, brackish water, and effluent). The membranes may be semi-permeable barriers that may allow water molecules to pass through while blocking larger molecules (such as those of salts, contaminants, and impurities). Further, the performance of membranes may refer to the efficiency and effectiveness of the membranes to generate clean water (also referred to as permeate or fresh water) from seawater. The performance of the membranes in the RO system may be used as a proxy to assess a scaling potential of salts and biofouling within the membrane, which may impair a capability of the membranes to produce the permeate. The scaling potential of the salts and the biofouling may refer to their tendency to precipitate and form scale deposits on surfaces of the membranes. Also, as membranes age and go through their operational lifetime, they tend to reduce their permeability, and salt passage to the permeate may increase tendentially (i.e., the permeate may become more saline). Therefore, there is a need for a system capable of assessing the scaling and biofouling potential of the membranes in the RO system.

According to one embodiment, a control system for monitoring membrane performance of reverse osmosis systems may be provided herein. The control system may include at least one non-transitory memory configured to store computer-executable instructions, and at least one processor configured to execute the computer-executable instructions to control a first movement of a separator from an initial position to a first position within the permeate tube based on a determination of at least one of a trigger point from a set of trigger points. The processor is further configured to determine a first flowrate of a permeate flowing through a first membrane of a set of membranes based on the first movement of the separator. The processor is further configured to calculate a first flux for a first membrane based on the determined first flowrate of the permeate and a first surface area of the first membrane. The processor is further configured to render the calculated first flux on a display screen.

In additional embodiments, the set of trigger points are associated with an average flux of the RO system or any membrane of the set of membranes on a pressure vessel of the RO system is lower than a minimum flux threshold or greater than a maximum flux threshold, an average brine flowrate of the RO system or any membrane of the set of membranes on the pressure vessel is lower than a minimum brine flowrate threshold or greater than a maximum brine flowrate threshold, an average permeate flowrate of the RO system or of any membrane of the set of membranes on the pressure vessel is lower than a minimum permeate flowrate threshold or greater than a maximum permeate flowrate threshold, an average recovery rate of the RO system or of any membrane of the set of membranes on the pressure vessel is lower than a minimum recovery rate threshold or greater than a maximum recovery rate threshold, an average brine-to-permeate ratio of the RO system or of the set of membranes on the pressure vessel is lower than a minimum brine-to-permeate threshold or greater than a maximum brine-to-permeate threshold, a change in temperature of a feedwater, or a change in an electrical conductivity of the feedwater, or a change in a potential of hydrogen (pH) of the feedwater, a change in a permeate flowrate produced by the RO system or of any individual membrane of the set of membranes on the pressure vessel, or a change in the electrical conductivity of the permeate produced by the RO system or of any individual membrane of the set of membranes on the pressure vessel, or a change in the pH of the permeate produced by the RO system or any individual membrane of the set of membranes on the pressure vessel, or a change in a concentration of at least one ion present in the permeate produced by the RO system or of any individual membrane of the set of membranes on the pressure vessel or a change in a feedwater pressure required to operate the RO system, or a change in a pressure differential between feedwater an inlet and an outlet on the RO system or any individual pressure vessel.

In additional embodiments, the first position is between the first membrane and a second membrane of the set of membranes.

In additional embodiments, the processor is further configured to control a second movement of the separator from the first position to a second position within the permeate tube based on the calculation of the first flux. The second position is between a second membrane and a third membrane of the set of membranes. The processor is further configured to determine a first collective flowrate of the permeate from the first membrane and the second membrane based on the second movement of the separator. The processor is further configured to render the determined first collective flowrate on the display screen.

In additional embodiments, the processor is further configured to determine a second flowrate of the permeate flowing through the second membrane based on the determined first collective flowrate, and the determined first flowrate. The processor is further configured to calculate a second flux for the second membrane of the set of membranes based on the determined second flowrate, and a second surface area of the second membrane of the set of membranes. The processor is further configured to render the calculated second flux on the display screen.

In additional embodiments, the second flowrate is determined by subtracting the first flowrate from the first collective flowrate.

In additional embodiments, the at least one processor is further configured to control a set of sensors to capture a set of parameters associated with the permeate flowing through at least the first membrane of the set of membranes. The set of sensors may be embedded within at least one of the separator or the permeate tube of the RO system. The processor is further configured to render the captured set of parameters on the display screen. The captured set of parameters comprises at least one of a first temperature, a first pH, a first salinity, a first alkalinity, a first hardness, a first pressure, and a first amount of chemicals associated with the permeate flowing through the first membrane of the set of membranes.

In additional embodiments, the processor is further configured to calculate a first set of metrics associated with the permeate flowing through the first membrane. The first set of metrics includes at least one of a first permeate flowrate, a first brine flowrate, a first feedwater flowrate, or a first electrical conductivity of the flowing through the first membrane based on the captured set of parameters. The processor is further configured to render at least one of the first set of metrics on the display screen.

In additional embodiments, the processor is further configured to calculate a second set of metrics. The second set of metrics includes at least one of a second recovery rate, a second permeate flowrate, a second brine flowrate, a second feedwater flowrate, a second brine-to-permeate ratio, a second electrical conductivity of the permeate or a second permeate flowrate associated with the permeate flowing through a second membrane based on at least one of the calculated first set of metrics, the captured first set of parameters and a second set of parameters associated with the permeate flowing through the second membrane of the set of membranes. The processor is further configured to render at least one of the second set of metrics on the display screen.

In additional embodiments, the processor is configured to determine, based on the calculated first flux for the first membrane, one or more suggestions for maintaining at least one of the average flux of the RO system between the minimum threshold and the maximum flux threshold, the average brine flowrate of the RO system between the minimum brine flowrate threshold and the maximum brine flowrate, the average recovery rate of the RO system above a minimum recovery rate threshold, or an average brine-to-permeate ratio above a minimum brine-to-permeate threshold. The processor is further configured to render the determined one or more suggestions on the display screen.

In additional embodiments, the determined one or more suggestions are associated with the set of membranes of the RO system.

According to another embodiment, a reverse osmosis (RO) system configured to monitor membrane performance of RO systems is provided. The RO system may include a set of membranes, a permeate tube present inside the set of membranes, a separator embedded inside the permeate tube, a bypass tube connected to a first outlet, and a second outlet of the permeate tube to equalize a pressure of a permeate at a first portion of the permeate tube and a second portion of the permeate tube. The RO system further includes at least one non-transitory memory configured to store computer-executable instructions. The RO system further includes at least one processor configured to execute the computer-executable instructions to control a first movement of the separator embedded in the permeate tube from an initial position to a first position within the permeate tube. The processor is further configured to determine a first flowrate of the permeate flowing through a first membrane of the set of membranes based on the first movement of the separator. The processor is further configured to calculate a first flux for the first membrane based on the determined first flowrate of the permeate and a first surface area of the first membrane. The processor is further configured to render the calculated first flux on a display screen.

In additional RO system embodiments, the RO system further includes a set of pressure vessels. Each pressure vessel of the set of pressure vessels may include the set of membranes. The RO system further includes a set of control valves within the pressure vessel. At least one of the set of control valves may be utilized to intake or discharge at least one of a feed water or a brine.

In additional RO system embodiments, the separator corresponds to at least one of a disk, a plug, or a sponge ball.

In additional RO system embodiments, the RO system may further include at least one electromechanical device. The electromechanical device is configured to control a movement of the separator throughout the permeable tube.

In additional RO system embodiments, the first position is between the first membrane and a second membrane of the set of membranes.

In additional RO system embodiments, the processor is further configured to control a second movement of the separator from the first position to a second position within the permeate tube after the calculation of the first flux. The second position is between a second membrane and a third membrane of the set of membranes. The processor is further configured to determine a first collective flowrate of the permeate from the first membrane and the second membrane based on the second movement of the separator. The processor is further configured to render the determined first collective flowrate on the display screen.

In additional RO system embodiments, the processor is further configured to determine a second flowrate of the permeate flowing through the second membrane based on the determined first collective flowrate, and the determined first flowrate. The processor is further configured to determine a second surface area of the second membrane of the set of membranes. The processor is further configured to calculate the second flux for the second membrane of the set of membranes based on the determined second flowrate, and the determined second surface area. The processor is further configured to render the calculated second flux on the display screen.

In additional RO system embodiments, the processor is further configured to control the set of sensors to capture a set of parameters associated with the permeate flowing through at least the first membrane of the set of membranes. The set of sensors are embedded within at least one of the separator or the permeate tube. The processor is further configured to render the captured first set of parameters on the display screen. The captured first set of parameters comprises at least one of a first temperature, a first pH, a first salinity, a first alkalinity, a first hardness, a first pressure, and a first amount of chemicals associated with the permeate flowing through the first membrane of the set of membranes.

According to another embodiment, a method for controlling a movement of a separator is provided. The method may include controlling a first movement of a separator, embedded within a permeate tube of a reverse osmosis (RO) system, from an initial position to a first position within the permeate tube based on a determination that at least one of a trigger point from a set of trigger points. The method further includes determining a first flowrate of a permeate flowing through a first membrane of the set of membranes based on the first movement of the separator. The method further includes calculating a first flux for the first membrane based on the determined first flowrate of the permeate and a first surface area of the first membrane. To this end, the method further includes rendering the calculated first flux on a display screen.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

Having thus described exemplary embodiments of the disclosure in general terms, reference will now be made to the accompanying drawings, which are not necessarily drawn to scale, and wherein:

FIG. 1 illustrates a schematic diagram of a network environment for monitoring the membrane performance of a reverse osmosis (RO) system, in accordance with an embodiment of the present disclosure;

FIG. 2 illustrates a block diagram of the control system of FIG. 1, in accordance with an embodiment of the present disclosure;

FIG. 3 illustrates a block diagram of the RO system of FIG. 1, in accordance with an embodiment of the present disclosure;

FIG. 4A illustrates a schematic diagram depicting a first position of the separator within the RO system, in accordance with an embodiment of the present disclosure;

FIG. 4B illustrates a schematic diagram depicting a second position of the separator within the RO system, in accordance with an embodiment of the present disclosure;

FIG. 5 is a diagram that illustrates exemplary operations for monitoring the membrane performance of the reverse osmosis system, in accordance with an embodiment of the present disclosure;

FIG. 6 illustrates a schematic diagram of a display screen utilized for rendering the calculated flux, in accordance with an embodiment of the present disclosure;

FIG. 7 illustrates a flowchart of a method implemented by the control system for monitoring membrane performance of the RO system, in accordance with an embodiment of the present disclosure; and

FIG. 8 illustrates a flowchart of a method implemented by the RO system for monitoring membrane performance of the RO system, in accordance with an embodiment of the present disclosure.

### DETAILED DESCRIPTION

In the following description, for purposes of explanation, numerous specific details are set forth in order to provide a thorough understanding of the present disclosure. It will be apparent, however, to one skilled in the art that the present disclosure may be practiced without these specific details. In other instances, systems and methods are shown in block diagram form only to avoid obscuring the present disclosure.

Some embodiments of the present disclosure will now be described more fully hereinafter with reference to the accompanying drawings, in which some, but not all, embodiments of the disclosure are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout. Also, reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments.

Further, the terms “a” and “an” herein do not denote a limitation of quantity, but rather denote the presence of at least one of the referenced item. Moreover, various features are described which may be exhibited by some embodiments and not by others. Similarly, various requirements are described which may be requirements for some embodiments but not for other embodiments. As used herein, the terms “data,” “content,” “information,” and similar terms may be used interchangeably to refer to data capable of being displayed, transmitted, received and/or stored in accordance with embodiments of the present disclosure. Thus, use of any such terms should not be taken to limit the spirit and scope of embodiments of the present disclosure.

As defined herein, a “computer-readable storage medium,” which refers to a non-transitory physical storage medium (for example, volatile or non-volatile memory device), may be differentiated from a “computer-readable transmission medium,” which refers to an electromagnetic signal.

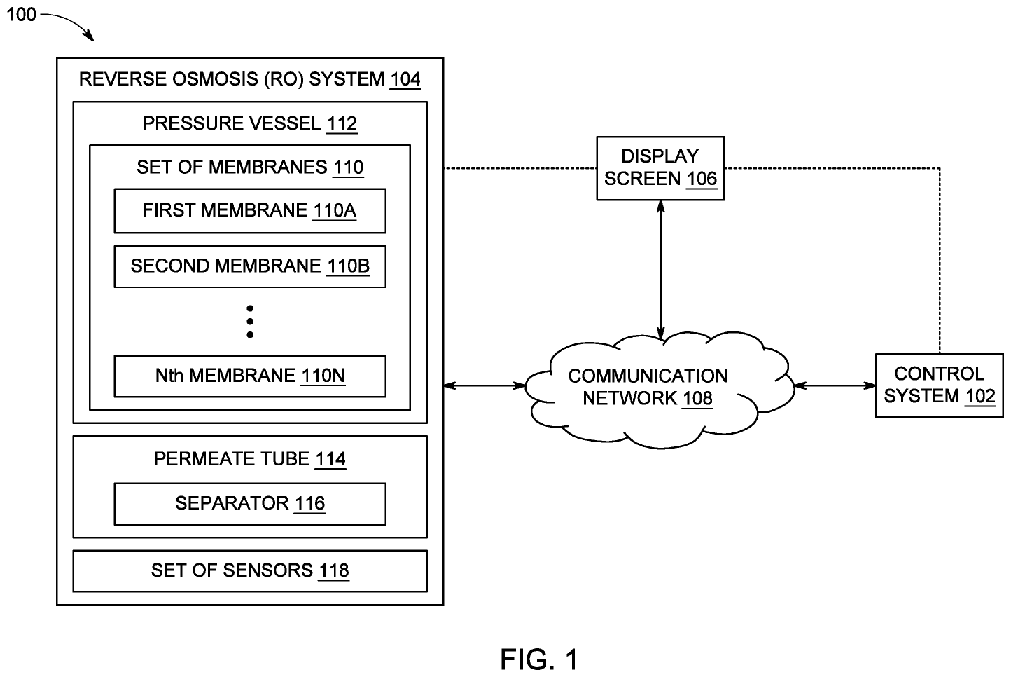

The embodiments are described herein for illustrative purposes and are subject to many variations. It is understood that various omissions and substitutions of equivalents are contemplated as circumstances may suggest or render expedient but are intended to cover the application or implementation without departing from the spirit or the scope of the present disclosure. Further, it is to be understood that the phraseology and terminology employed herein are for the purpose of the description and should not be regarded as limiting. Any heading utilized within this description is for convenience only and has no legal or limiting effect. Turning now to FIG. 1-FIG. 8, a brief description concerning the various components of the present disclosure will now be briefly discussed.

A control system, a reverse osmosis (RO) system, and a method are provided herein in accordance with an example embodiment for monitoring the performance of a set of membranes in the RO system and further calculating and displaying a flux associated with each membrane of the RO system.

Traditionally, one of the metrics used to assess a performance of semi-permeable membranes of the RO system is called as flux. The flux may be defined as an amount of water that passes (permeates) through the semi-permeable membrane during a given time. Usually, an average flux of all the semi-permeable membranes of the RO system is compared with a threshold to determine the performance of the RO system. For example, in case the average flux is greater than the threshold flux, it may be deemed that the RO system is working above a desired production capacity whereas if the average flux is less than the threshold flux, it may be deemed as the RO system is working below the desired production capacity and hence the performance of the RO system is degraded.

In cases where the flux of the RO system is below the threshold, amongst others, a common solution is to clean each semi-permeable membrane of the RO system using chemicals or to replace each semi-permeable membrane of the RO system. Such solutions are time-consuming, cumbersome, as well as expensive to implement. Therefore, it becomes critical to know about the membrane performance of each of the membranes to take action about cleaning or replacement of a particular membrane rather than cleaning or replacing all the membranes of the RO system.

The disclosed control system and/or the RO system may monitor a set of metrics which may include the flux of each membrane of the RO system and use the monitored flux as a proxy for assessing the scaling and biofouling potential of the corresponding membrane of the RO system. All the other parameters measured by the control system and/or the RO system may also aid in the assessment of the performance of the membranes (referred to as, a set of membranes, hereinafter) and optimize the efficiency of the RO system.

The disclosed control system and/or the RO system may be further capable of determining the performance of each membrane in the RO system online without any sort of manual intervention, even while the RO system is operational. Therefore, the disclosed control system and/or the RO system may be able to perform the desired operations without impacting normal operations and without disrupting the production capability of the RO system. Moreover, the disclosed control system and/or the RO system may significantly aid operators of the RO system to run their RO plants efficiently and safely near their technical limits. The disclosed control system and/or the RO system may also result in cost-saving and time-saving for the operators as they may be required to replace (or clean) a few membranes whose performance has deteriorated instead of replacing or cleaning all the membranes of the RO system as done traditionally.

FIG. 1 illustrates a schematic diagram of a network environment 100 for monitoring the membrane performance of a reverse osmosis (RO) system, in accordance with an embodiment of the present disclosure. The network environment 100 may include a control system 102, an RO system 104, a display screen 106, and a communication network 108. The control system 102, the RO system 104, and the display screen 106 may be communicatively coupled using the communication network 108. Further, the RO system 104 may also include a set of membranes 110 including N number of membranes that may be arranged sequentially in a pressure vessel 112. As an example, the N may be any natural number, for example, for N=3, the number of membranes may be three, i.e., a first membrane 110A, a second membrane 110B, and an N^{th} membrane 110N (or a third membrane). Further, the RO system 104 may also include a permeate tube 114, and a separator 116 embedded in the permeate tube 114. The RO system 104 may also include a set of sensors 118.

The control system 102 may include suitable logic, circuitry, interfaces, and/or code that may be configured to monitor the performance of each membrane of the set of membranes 110 of the RO system 104. Specifically, the control system 102 may be configured to control a movement of the separator 116 and monitor the performance of each membrane of the set of membranes 110 based on the movement of the separator 116. Examples of the control system 102 may include but are not limited to a computing device, a mainframe machine, a server, a computer work-station, a smartphone, a cellular phone, a mobile phone, a gaming device, and a consumer electronic (CE) device. In an embodiment, the control system 102 may correspond to a digital control and monitoring system (DCMS) that may be capable of monitoring and controlling operations of one or more components of the RO system 104.

The control system 102 may be further configured to assess a plurality of metrics associated with the RO system 104. The plurality of metrics may include the individual flux of each membrane of the set of membranes 110 of the RO system 104 together with the measurement of all the flowrates inside each of the membranes of the set of membranes 110 installed in the pressure vessel 112. In an embodiment, the flowrate of the permeate flowing through the membrane per surface area per unit of time inside the membranes may be called a flux of the corresponding membrane and may be typically measured in litres per square meter per hour (litres/meter²/hour).

The RO system 104 may be a water filtration system that effectively removes impurities (such as ions, molecules, contaminants, and larger particles) from feedwater. The RO system 104 may work on a principle of reverse osmosis (RO) for desalination. The RO system 104 may include the set of membranes 110 to remove the impurities from the feedwater. The RO system 104 may work by applying a pressure to the feedwater, causing the feedwater to pass through the set of membranes 110 of the RO system 104 and separating the permeate (or freshwater) from the salts, the impurities, and the contaminants. The permeate may be collected while the salts, the impurities, and the contaminants may be flushed away with brine (or wastewater). Specifically, the RO system 104 may effectively filter out contaminants such as minerals, bacteria, viruses, and chemicals from the feed water, making it safe and suitable for drinking, cooking, and other household uses.

There are various examples of the RO system 104 used in different applications. For example, in industrial settings, large-scale RO systems (e.g., the SWRO plant or BWRO plant) may be used for desalination. The SWRO plant or the BWRO plant may include multiple RO systems 104. The SWRO plant (or the BWRO plant) may be a type of desalination plant that may use the reverse osmosis to convert seawater (or the brackish water) into freshwater. The process of converting seawater into freshwater may involve forcing seawater (or the brackish water) through the set of membranes 110 that may only allow water molecules to pass through while filtering out salt and the impurities (for example, biofouling). In the field of residential water purification, a popular example is an under-sink RO system. This system is installed under a kitchen sink and provides purified drinking water directly from a dedicated faucet. Further, the resulting freshwater may then be stored in a tank, ready for distribution.

The display screen 106 may comprise suitable logic, circuitry, and interfaces that may be configured to display the calculated flux of at least one membrane of the set of membranes 110. In an embodiment, the display screen 106 may be further configured to display the flowrate of at least one of the feed water, the brine, and the permeate in the RO system 104. In an embodiment, the display screen 106 may be further configured to display one or more suggestions. In some embodiments, the display screen 106 may be an external display device associated with the control system 102 or the RO system 104. The display screen 106 may be a touch screen which may enable one or more operators to provide one or more inputs via the display screen 106. The touch screen may be at least one of a resistive touch screen, a capacitive touch screen, or a thermal touch screen. The display screen 106 may be realized through several known technologies such as, but not limited to, at least one of a Liquid Crystal Display (LCD) display, a Light Emitting Diode (LED) display, a plasma display, or an Organic LED (OLED) display technology, or other display devices.

The communication network 108 may be wired, wireless, or any combination of wired and wireless communication networks, such as cellular, Wi-Fi, internet, local area networks, or the like. The communication network 108 may include a communication medium through which the control system 102, the RO system 104, and the display screen 106 may communicate with each other. In some embodiments, the communication network 108 may include one or more networks such as a data network, a wireless network, a telephony network, or any combination thereof. It is contemplated that the data network may be any local area network (LAN), metropolitan area network (MAN), wide area network (WAN), a public data network (e.g., the Internet), short-range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks (e.g. LTE-Advanced Pro), 5G New Radio networks, ITU-IMT 2020 networks, code division multiple access (CDMA), wideband code division multiple access (WCDMA), wireless fidelity (Wi-Fi), wireless LAN (WLAN), Bluetooth, Internet Protocol (IP) data casting, satellite, mobile ad-hoc network (MANET), and the like, or any combination thereof.

Each membrane of the set of membranes 110 may correspond to a semipermeable barrier that may selectively allow water molecules to pass through while blocking the passage of ions, molecules, and larger particles, effectively removing contaminants from the feedwater. Each RO membrane of the set of membranes 110 may be typically made from a thin, composite material that may have specific filtration properties. Examples of different types of membranes may include, but are not limited to, a thin film composite (TFC) membrane and a cellulose acetate (CA) membrane.

The pressure vessel 112 may correspond to a container or housing that may contain the set of membranes 110 and other necessary components of the RO system 104. The pressure vessel 112 may be designed to withstand the high pressure required for the process of RO. The pressure vessel 112 may be typically cylindrical in shape and may be made of rigid and durable materials such as fiberglass, stainless steel, or other corrosion-resistant materials. Inside the pressure vessel 112, the set of membranes 110 may be housed in a spiral configuration or placed in a tubular shape. The pressure vessel 112 may provide a secure environment for the set of membranes 110, ensuring that the set of membranes 110 is properly sealed and protected. During operation, the pressure vessel 112 may be subjected to high-pressure conditions. The feed water may be introduced into the pressure vessel 112, and the pressure exerted on the set of membranes 110 may help drive the water molecules through the set of membranes 110 while rejecting impurities. The pressure vessel 112, thus facilitates the separation of purified water (permeate) from the concentrated impurities (concentrate or brine).

The permeate tube 114 may be used to collect the purified water or permeate produced by the set of membranes 110 of the RO system 104. The permeate tube 114 may be connected to an outlet side of each membrane and may be responsible for carrying the purified water away from the corresponding membrane. As the water molecules pass through the set of membranes 110, they may enter the permeate tube 114 and may be directed toward a water storage tank or a distribution system. The permeate tube 114 is usually made of a material that is compatible with water, such as food-grade plastic or stainless steel, to ensure that the permeate remains uncontaminated. In some embodiments, the permeate tube 114 may also be referred to as a product tube or a membrane tube.

The separator 116 in the RO system 104 may be a component or device that may be used to separate different streams of water within the set of membranes 110 of the RO system 104. The separator 116 may be made of a material that acts as an isolation separator, stopping the passage of permeation from one side to the other inside the permeate tube 114. The separator 116 may be of various types, depending on a specific design and application. For example, the separator 116 may be a type of flow restrictor that may restrict or stop the movement of a flow of the permeate. In an embodiment, the separator 116 may be embedded within the permeate tube 114 and may correspond to at least one of a disk, a plug, or a sponge ball. It may be noted that the disk, the plug, or the sponge ball are mentioned as examples of the separator 116. The separator 116 may not be limited to the disk, the plug, or the sponge ball only and may be of another form, shape, or size depending on the particular implementation.

Each of the set of sensors 118 may include suitable logic, circuitry, and interfaces, and/or code that may be configured to capture a corresponding parameter of a set of parameters. In an embodiment, each of the set of sensors 118 may be integrated within the RO system 104. The set of sensors 118 may include at least one of a temperature sensor, a potential of hydrogen (pH) sensor, an alkalinity sensor, a hardness sensor, an oxidation-reduction potential (ORP) sensor, a pressure sensor, and a conductivity sensor.

In operation, the RO system 104 may be used for the desalination of seawater to generate the permeate (or fresh water). The RO system 104 intakes the seawater as feed water and separates the salts and/or impurities by pressurizing the seawater through the set of membranes 110. Further, the freshwater or the permeate separated from the seawater through the set of membranes 110 may be collected in the permeate tube 114. The flowrate of the permeate collected in the permeate tube 114 may be utilized by the control system 102 to calculate an average flux for the RO system 104. Further, the control system 102 may be further configured to determine the average brine flowrate of the RO system 104, an average recovery rate of the RO system 104, and an average brine-to-permeate ratio of the RO system 104 based on the flowrate of the permeate collected in the permeate tube 114.

As discussed above, the flux of the RO system 104 may correspond to a flowrate of permeate flow through each membrane of the set of membranes 110 and may measure the volume of water that passes through the membrane per unit of time. The flux is typically expressed as gallons per day (GPD) or litres per square meter per hour (litres/meter²/hour or LPH) and may indicate the performance of the RO system 104 in terms of the production of the permeate. A higher flux value may indicate a greater volume of water output. The brine flowrate of the RO system 104 may refer to the rate at which the brine (or the concentrated water) is being discharged from the RO system 104. This flowrate is typically measured in gallons per minute (GPM) or cubic meters per hour (m³/h). The recovery rate of the RO system 104 may refer to a percentage of feedwater that may be successfully processed to the permeate and made available for use, compared to the total amount of feedwater that enters the RO system 104. The brine-to-permeate ratio of the RO system 104 may refer to the amount of brine produced compared to the amount of permeate produced. It is calculated by dividing the volume of brine by the volume of permeate.

It may be determined that at least one of the average flux of the RO system 104 may be lower than a minimum flux threshold or greater than a maximum flux threshold. In another embodiment, it may be determined that the average brine flowrate of the RO system 104 may be lower than a minimum brine flowrate threshold or greater than a maximum brine flowrate threshold, the average recovery rate of the RO system 104 is lower than a minimum recovery rate threshold or greater than a maximum recovery rate threshold, or the average brine-to-permeate ratio of the RO system 104 is greater than a minimum brine-to-permeate ratio threshold or less than a maximum brine-to-permeate threshold.

The minimum flux threshold and the maximum flux threshold may correspond to a minimum and a maximum value of the flux of the RO system 104. It may be desired that the average flux of the RO system 104 may be between the minimum flux threshold and the maximum flux threshold. The minimum brine flowrate threshold and the maximum brine flowrate threshold may correspond to a minimum and a maximum value of the brine flowrate of the RO system 104. It may be desired that the average brine flowrate of the RO system 104 may be between the minimum brine flowrate threshold and the maximum brine flowrate threshold. The minimum recovery rate threshold and the maximum brine flowrate threshold may correspond to a minimum and a maximum value of the recovery rate of the RO system 104. It may be desired that the average recovery rate threshold of the RO system 104 may be between the minimum recovery rate threshold and the maximum recovery rate threshold. Similarly, the minimum brine-to-permeate ratio threshold and the maximum brine-to-permeate ratio threshold may correspond to a minimum and a maximum value of the brine-to-permeate ratio of the RO system 104. It may be desired that the average brine-to-permeate ratio of the RO system 104 may be between the minimum brine-to-permeate ratio threshold and the maximum brine-to-permeate threshold.

Based on the determination of at least one of the trigger points from the set of trigger points. The trigger points are associated with the average flux of the RO system 104 or any membrane of the set of membranes 110 on the pressure vessel 112 is lower than the minimum flux threshold or greater than the maximum flux threshold, the average brine flowrate of the RO system 104 or any membrane of the set of membranes 110 on the pressure vessel 112 is lower than the minimum brine flowrate threshold or greater than the maximum brine flowrate threshold, the average permeate flowrate of the RO system 104 or any membrane of the set of membranes 110 on the pressure vessel 112 is lower than the minimum permeate flowrate threshold or greater than a maximum permeate flowrate threshold, the average recovery rate of the RO system 104 or any membrane of the set of membranes 110 on the pressure vessel 112 is greater than the minimum recovery rate threshold or less than the maximum recovery rate threshold, or the average brine-to-permeate ratio of the RO system 104 or of the set of membranes 110 on the pressure vessel 112 is greater than the minimum brine-to-permeate ratio threshold or less than a maximum brine-to-permeate threshold, a change in temperature of the feedwater, a change in the electrical conductivity of the feedwater, the change in the pH of the feedwater, the change in the permeate flowrate produced by the RO system 104 or of any individual membrane of the set of membranes 110 on the pressure vessel 112, the change in the pH of the permeate produced by the RO system or of any individual membrane of the set of membrane 110 on the pressure vessel 112, the change in the concentration of at least one ion present in the permeate produced by the RO system 104 or of any individual membrane of the set of membranes 110 on the pressure vessel 112, a change in a feedwater pressure required to operate the RO system 104, or a change in a pressure differential between feedwater an inlet and an outlet on the RO system 104 or any individual pressure vessel 112. In an embodiment, the trigger point may be determined whenever one condition may be breached. For example, the trigger point may be determined when the average flux of the RO system 104 or any membrane of the set of membranes 110 on the pressure vessel 112 is lower than the minimum flux threshold or greater than the maximum flux threshold. The trigger point may be determined when the average brine flowrate of the RO system 104 or any membrane of the set of membranes 110 on the pressure vessel 112 is lower than the minimum brine flowrate threshold or greater than the maximum brine flowrate threshold, and so on.

It may be noted that the disclosure may not be limited to the above mentioned set of trigger points. In an embodiment, the operator of the control system 102 may add more trigger points associated with one or more parameters of the RO system 104 at their discretion.

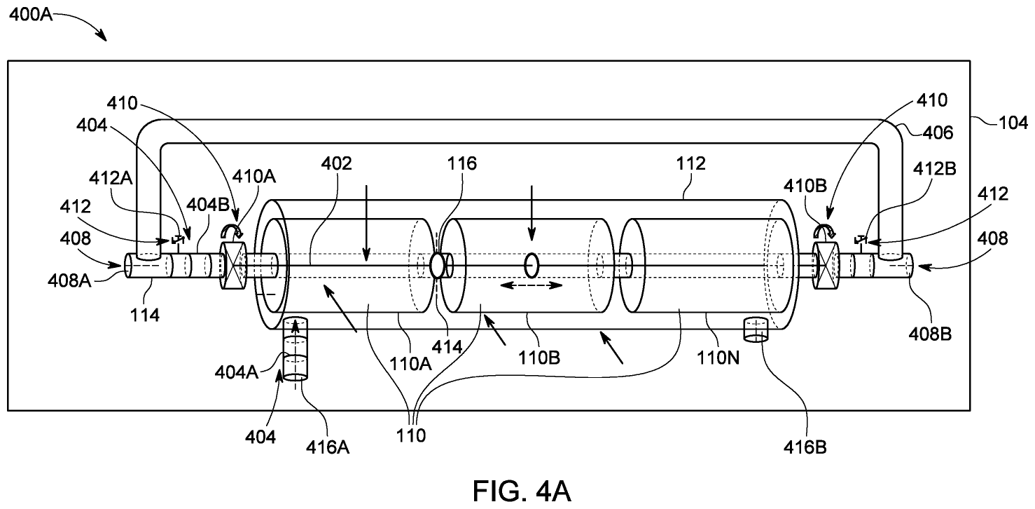

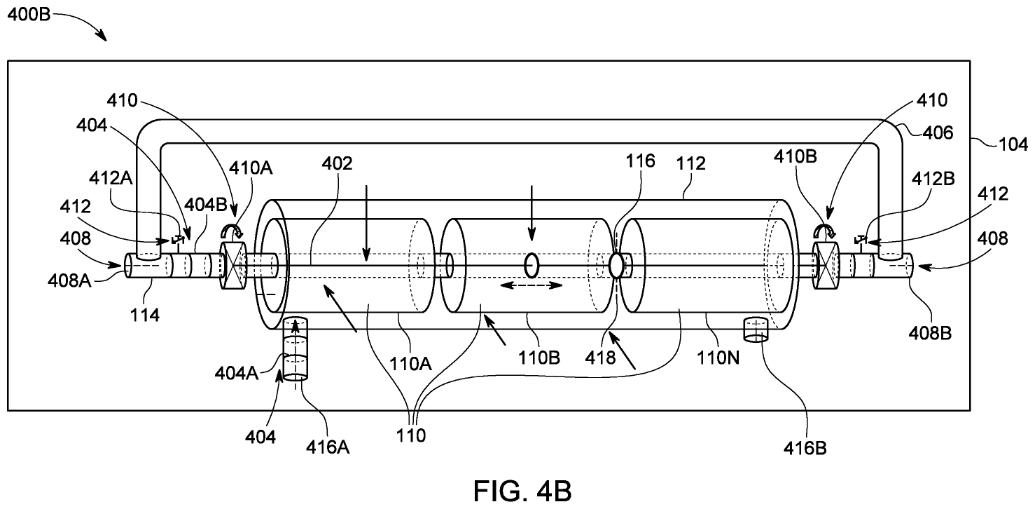

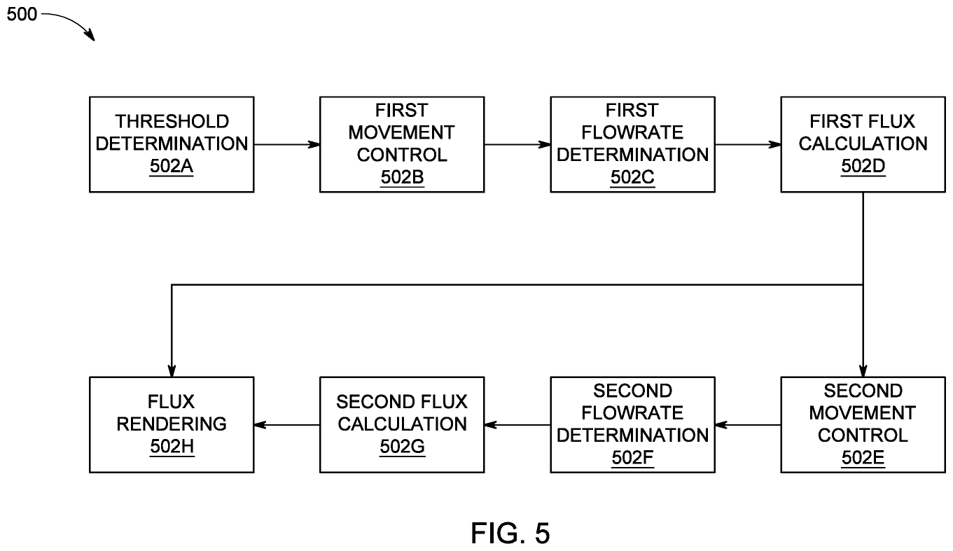

The control system 102 may be configured to control a first movement of the separator 116 to instate the separator 116 at a first position within the permeate tube 114 from an initial position of the separator 116. In an embodiment, the control system 102 may be configured to control the first movement of the separator 116 based on a reception of a user input received from the operator of the RO system 104. The user input may be received from the operator of the RO system 104 when a service of the RO system 104 may be due or the performance of the RO system 104 has deteriorated. The first position may be between the first membrane 110A and the second membrane 110B of the set of membranes 110. At the first position, the separator 116 may be able to isolate the permeate flowing through the first membrane 110A and the permeate flowing through the remaining membranes of the set of membranes 110. Details about the first movement and the first position are provided, for example, in FIG. 4A, and FIG. 5.

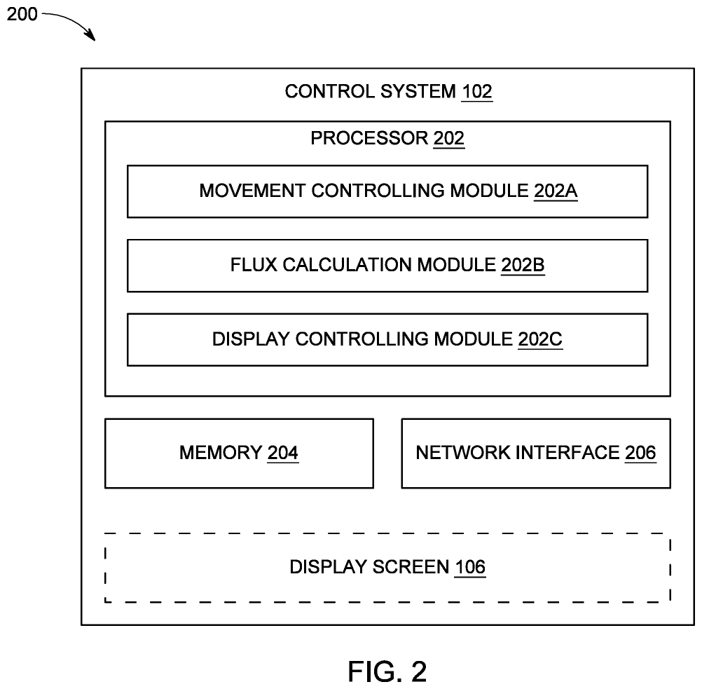

The control system 102 may be further configured to determine a first flowrate of the permeate flowing through the first membrane 110A of the set of membranes 110 based on the first movement of the separator 116. The control system 102 may be configured to calculate a first flux for the first membrane 110A based on the determined first flowrate of the permeate and a first surface area of the first membrane 110A. Details about the calculation of the first flux are provided, for example, in FIG. 2, FIG. 4A, and FIG. 5.

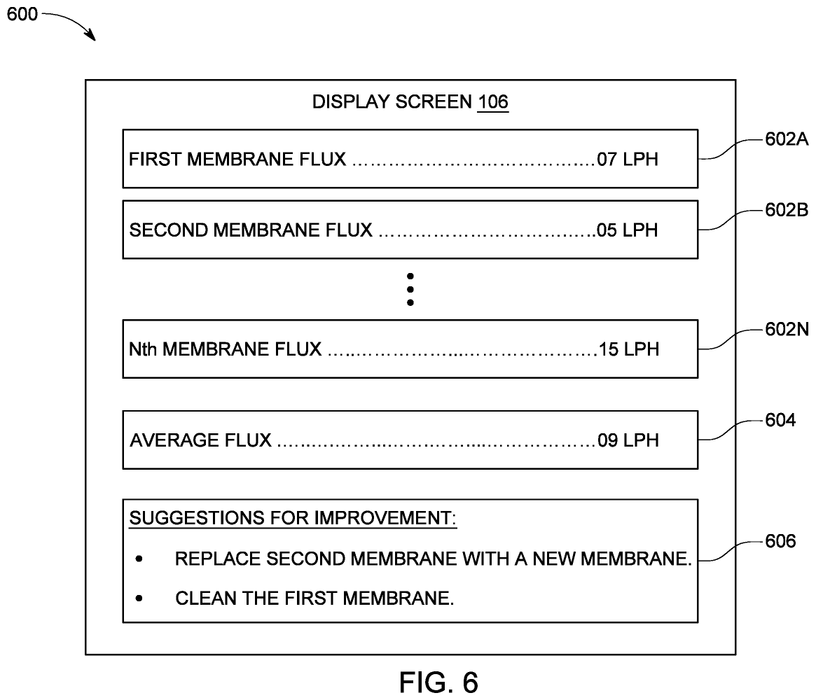

To that end, the calculated first flux may be rendered on the display screen 106. The calculated first flux may also be utilized by the control system 102 to determine the performance and/or working condition of the first membrane 110A. Similarly, the control system 102 may be configured to calculate flux for each membrane of the set of membranes 110 of the RO system 104 and may provide one or more suggestions to the one or more operators of the RO system 104 to maintain the metrics (such as the average flux, the average brine flowrate, the average recovery rate, and the average brine-to-permeate ratio) associated with the RO system 104 within their corresponding threshold limits. Based on the calculated flux for each membrane, an operator of the RO system 104 may decide to replace, clean, or continue using the corresponding membrane of the set of membranes 110. This can be cost-effective, and less time-consuming as only the membrane whose performance has been deteriorated can be replaced or cleaned as compared to the replacement or cleaning of each membrane of the RO system 104. Details about the rendering of the first flux are provided, for example, in FIG. 6

It may be noted that although the control system 102 and the RO system 104 are shown as two separate entities, the disclosure may not be limited to such an implementation only. In some instances, the control system 102 may be embedded within the RO system 104. It may be further noted that although the control system 102, the RO system 104, and the display screen 106 are shown as separate entities, the disclosure may not be limited to such an implementation only. In some instances, the display screen 106 may be embedded within the control system 102 or the RO system 104.

FIG. 2 illustrates a block diagram of the control system of FIG. 1, in accordance with an embodiment of the present disclosure. FIG. 2 is explained in conjunction with elements from FIG. 1. With reference to FIG. 2, there is shown the control system 102 of FIG. 1. The control system 102 may include at least one processor 202 (referred to as processor 202 hereinafter), at least one non-transitory memory 204 (referred to as memory 204 hereinafter), a network interface 206, and the display screen 106. The processor 202 may further include a set of modules 202A-202C that includes a movement controlling module 202A, a flux calculation module 202B, and a display controlling module 202C. Each module of the set of modules 202A-202C may be implemented in hardware, firmware, software, or a combination thereof. In one embodiment, each module of the set of modules 202A-202C may be implemented as a cloud-based service, local service, native application, or combination thereof. The functions of the control system 102 and the set of modules 202A-202C are discussed with respect to the figures below.

The processor 202 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor 202 may include one or more processing cores configured to perform independently. A multi-core processor may enable multiprocessing within a single physical package. Additionally or alternatively, the processor 202 may include one or more processors configured in tandem via the bus to enable independent execution of instructions, pipelining, and/or multithreading. Additionally or alternatively, the processor 202 may include one or more processors capable of processing large volumes of workloads and operations to provide support for data analysis. In an example embodiment, the processor 202 may be in communication with the memory 204 via a bus for passing information among components of the control system 102. In an example embodiment, the processor 202 may be configured to perform one or more methods of the method explained in the disclosure.

For example, when the processor 202 is embodied as an executor of software instructions, the instructions may specifically configure the processor 202 to perform the algorithms and/or operations described herein when the instructions are executed. However, in some cases, the processor 202 may be a processor-specific device (for example, a mobile terminal or a fixed computing device) configured to employ an embodiment of the present disclosure by further configuration of the processor 202 by instructions for performing the algorithms and/or operations described herein. The processor 202 may include, among other things, a clock, an arithmetic logic unit (ALU), and logic gates configured to support the operation of the processor 202.

The movement controlling module 202A of the processor 202 may be configured to control one or more movements of the separator 116. The one or more movements of the separator 116 may include the first movement, the second movement, and the like. For example, the movement controlling module 202A may control the movement of the separator 116 inside the permeate tube 114 for isolating the permeate generated by the set of membranes 110. In one embodiment, the movement control module 202A may control the first movement of the separator 116 embedded in the permeate tube 114 of the reverse osmosis (RO) system 104.

The flux calculation module 202B of the processor 202 may be configured to calculate the flux of each membrane of the set of the RO system 104. The flux calculation module 202B of the processor 202 may be further configured to calculate the first flux for the first membrane 110A based on the determined first flowrate of the permeate and a first surface area of the first membrane 110A. The first flux may be expressed in terms of gallons per square foot per day (GFD) and/or litres/meter²/hour. Similarly, the flux calculation module 202B may be configured to calculate flux for each membrane of the set of membranes 110 in the RO system 104. A higher value of flux may correspond to the ability of the membrane to allow a greater flow rate of the permeate through it. Details about the calculation of the flux are further explained, for example, in FIG. 4A, FIG. 4B, and FIG. 5.

The display controlling module 202C of the processor 202 may be configured to control the display screen 106 to render the calculated first flux on the display screen 106. For example, the calculated first flux may be displayed on the display screen 106 in such a manner that may enable the one or more operators to find out and monitor the performance of the set of membranes 110 of the RO system 104. Further, the display controlling module 202C may also render the flux for each membrane of the set of membranes 110 on the display screen 106 after the calculation of flux for each membrane of the set of membranes 110. In an embodiment, the calculated flux may be represented as visually dynamic and interactive graphics, charts, or numerical data. The visual representation may provide real-time updates and visualization of the calculated flux. The display controlling module 202C may also allow the one or more operators to easily interpret and analyze data associated with the set of membranes 110 based on the calculated flux. Details about displaying the calculated flux are further explained, for example, in FIG. 6.

The memory 204 may be an electronic storage device (for example, a computer readable storage medium) comprising gates configured to store data (for example, bits) that may be retrievable by a machine (for example, a computing device like the processor 202). The memory 204 may be configured to store information, data, content, applications, instructions, or the like, for enabling the control system 102 to carry out various functions in accordance with an example embodiment of the present disclosure. For example, the memory 204 may be configured to buffer input data for processing by the processor 202. The memory 204 may be configured to store instructions for execution by the processor 202.

The memory 204 of the control system 102 may be configured to store data associated with, but not limited to, flowrate, flux, and the set of sensors 118 associated with the RO system 104. In accordance with an embodiment, the memory 204 may include processing instructions for processing the flowrate data. The dataset may include real-time data and historical data, for the RO system 104. Examples of implementation of the memory 204 may include, but are not limited to, Random Access Memory (RAM), Read Only Memory (ROM), Electrically Erasable Programmable Read-Only Memory (EEPROM), Hard Disk Drive (HDD), a Solid-State Drive (SSD), a CPU cache, and/or a Secure Digital (SD) card.

The network interface 206 may comprise suitable logic, circuitry, interfaces, and/or code that may be configured to establish communication between the control system 102, the RO system 104, and the display screen 106 via the communication network 108. The network interface 206 may be configured to implement known technologies to support wired or wireless communication. The network interface 206 may include, but is not limited to, an antenna, a radio frequency (RF) transceiver, one or more amplifiers, a tuner, one or more oscillators, a digital signal processor, a coder-decoder (CODEC) chipset, a subscriber identity module (SIM) card, and/or a local buffer.

The network interface 206 may be configured to communicate via offline and online wireless communication with networks, such as the Internet, an Intranet, and/or a wireless network, such as a cellular telephone network, a wireless local area network (WLAN), personal area network, and/or a metropolitan area network (MAN). The wireless communication may use any of a plurality of communication standards, protocols and technologies, such as Global System for Mobile Communications (GSM), Enhanced Data GSM Environment (EDGE), wideband code division multiple access (W-CDMA), code division multiple access (CDMA), LTE, time division multiple access (TDMA), Bluetooth, Wireless Fidelity (Wi-Fi) (such as IEEE 802.11, IEEE 802.11b, IEEE 802.11g, IEEE 802.11n, and/or any other IEEE 802.11 protocol), voice over Internet Protocol (VOIP), Wi-MAX, Internet-of-Things (IoT) technology, Machine-Type-Communication (MTC) technology, a protocol for email, instant messaging, and/or Short Message Service (SMS).

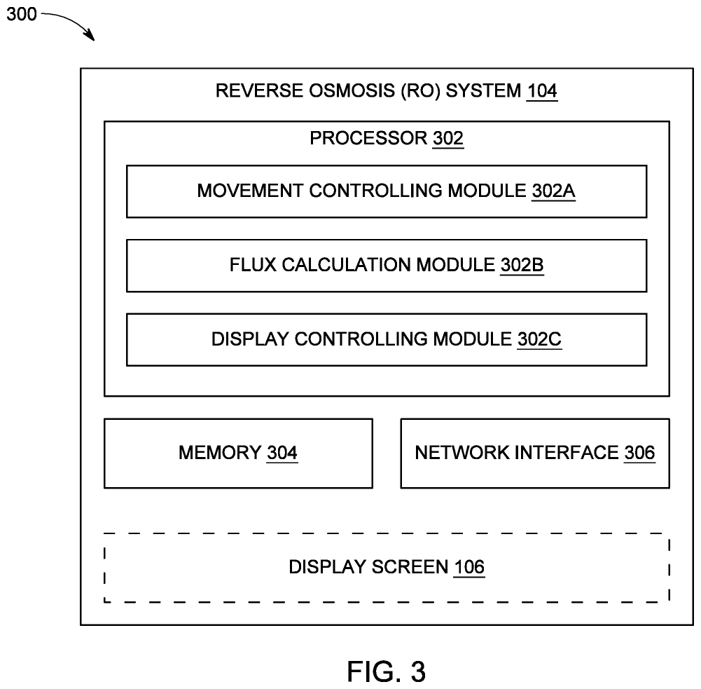

FIG. 3 illustrates a block diagram of the RO system of FIG. 1, in accordance with an embodiment of the present disclosure. FIG. 3 is explained in conjunction with elements from FIG. 1, and FIG. 2. With reference to FIG. 3, there is shown the RO system 104 of FIG. 1. The RO system 104 may include at least one processor 302 (referred to as processor 302 hereinafter), a memory 304, a network interface 306, and a display screen 308. The processor 302 may further include a set of modules 302A-302C that includes a movement controlling module 302A, a flux calculation module 302B, and a display controlling module 302C. Each module of the set of modules 302A-302C may be implemented in hardware, firmware, software, or a combination thereof. In one embodiment, each module of the set of modules 302A-302C may be implemented as a cloud-based service, local service, native application, or combination thereof. The functions of the RO system 104 and the set of modules 302A-302C are discussed with respect to the figures below.

The processor 302 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor 302 may include one or more processing cores configured to perform independently. A multi-core processor may enable multiprocessing within a single physical package. Additionally or alternatively, the processor 302 may include one or more processors configured in tandem via the bus to enable independent execution of instructions, pipelining, and/or multithreading. Additionally or alternatively, the processor 302 may include one or more processors capable of processing large volumes of workloads and operations to provide support for big data analysis. In an example embodiment, the processor 302 may be in communication with the memory 304 via a bus for passing information among components of the RO system 104. In an example embodiment, the processor 302 may be configured to perform one or more methods of the method explained in the disclosure.

For example, when the processor 302 is embodied as an executor of software instructions, the instructions may specifically configure the processor 302 to perform the algorithms and/or operations described herein when the instructions are executed. However, in some cases, the processor 302 may be a processor-specific device (for example, a mobile terminal or a fixed computing device) configured to employ an embodiment of the present disclosure by further configuration of the processor 302 by instructions for performing the algorithms and/or operations described herein. The processor 302 may include, among other things, a clock, an arithmetic logic unit (ALU), and logic gates configured to support the operation of the processor 302.

The movement controlling module 302A of the processor 302 may be configured to control one or more movements of the separator 116 embedded within the permeate tube 114 of the RO system 104. Other operations of the movement controlling module 302A may be similar to the movement controlling module 202A of the control system 102 and therefore, explanation of such operations is omitted for the sake of brevity.

The flux calculation module 302B of the processor 302 may be configured to calculate flux of each membrane of the set of the RO system 104. Other operations of the flux calculation module 302B may be similar to the flux calculation module 202B of the control system 102 and therefore, explanation of such operations is omitted for the sake of brevity.

The display controlling module 302C of the processor 302 may be configured to control the display screen 106 to render the calculated first flux on the display screen 106. For example, the calculated first flux may be displayed on the display screen 106 in such a manner that may enable the one or more operators to find out and monitor the performance of the set of membranes 110 of the RO system 104. Other operations of the display controlling module 302C may be similar to the display controlling module 202C of the control system 102 and therefore, explanation of such operations is omitted for the sake of brevity.

The memory 304 may be an electronic storage device (for example, a computer readable storage medium) comprising gates configured to store data (for example, bits) that may be retrievable by a machine (for example, a computing device like the processor 302). The memory 304 may be configured to store information, data, content, applications, instructions, or the like, to enable the RO system 104 to carry out various functions in accordance with an example embodiment of the present disclosure. For example, the memory 304 may be configured to buffer input data for processing by the processor 302. The memory 304 may be configured to store instructions for execution by the processor 302.

The memory 304 of the control system 102 may be configured to store data associated with, but not limited to, flowrate, flux, and the set of sensors 118 associated with the RO system 104. In accordance with an embodiment, the memory 304 may include processing instructions for processing the flowrate data. The dataset may include real-time data and historical data, for the RO system 104. Examples of implementation of the memory 304 may include, but are not limited to, Random Access Memory (RAM), Read Only Memory (ROM), Electrically Erasable Programmable Read-Only Memory (EEPROM), Hard Disk Drive (HDD), a Solid-State Drive (SSD), a CPU cache, and/or a Secure Digital (SD) card.

The network interface 306 may comprise suitable logic, circuitry, interfaces, and/or code that may be configured to establish communication between the RO system 104, the control system 102, and the display screen 106 via the communication network 108. The network interface 306 may be configured to implement known technologies to support wired or wireless communication. The network interface 306 may include, but is not limited to, the antenna, the RF transceiver, the one or more amplifiers, the tuner, the one or more oscillators, the digital signal processor, the CODEC chipset, the SIM card, and/or the local buffer.

The network interface 306 may be configured to communicate via offline and online wireless communication with networks, such as the Internet, an Intranet, and/or a wireless network, such as the cellular telephone network, the WLAN, the personal area network, and/or the MAN. The wireless communication may use any of a plurality of communication standards, protocols, and technologies, such as the GSM, the EDGE, the W-CDMA, the CDMA, the LTE, the TDMA, the Bluetooth, the Wi-Fi (such as IEEE 802.11, IEEE 802.11b, IEEE 802.11g, IEEE 802.11n, and/or any other IEEE 802.11 protocol), the VOIP, the Wi-MAX, the IoT technology, the MTC technology, the protocol for email, instant messaging, and/or SMS.

FIG. 4A illustrates a schematic diagram 400A depicting a first position of the separator 116 within the RO system 104, in accordance with an embodiment of the present disclosure. FIG. 4A is explained in conjunction with elements from FIG. 1, FIG. 2, and FIG. 3. With reference to FIG. 4A, there is shown the RO system 104 of FIG. 1. The RO system 104 may include the set of membranes 110, the pressure vessel 112, the permeate tube 114, and the separator 116. The RO system 104 may further include a cable 402 attached to the separator 116, a first flowmeter 404A and a second flowmeter 404B (collectively referred to as a set of flowmeters 404), a bypass tube 406 connected to a first outlet 408A and a second outlet 408B (collectively referred to as a set of outlets 408). The RO system 104 may further include a first electromechanical device 410A and a second electromechanical device 410B (collectively referred to as a set of electromechanical devices 410), a first stop check valve 412A and a second stop check valve 412B (collectively referred to as a set of stop check valves 412). FIG. 4A may also depict a first position 414 of the separator 116 within the RO system 104. Further, the RO system 104 may also include a first opening 416A and a second opening 416B associated with the pressure vessel 112. The first opening 416A may be an inlet used to intake the feedwater and the second opening 416B may be an outlet to output brine (or wastewater). In an embodiment, the RO system 104 may also include the processor 310 and the memory 312 (not shown).

The cable 402 may be attached to the separator 116 present inside the permeate tube 114 of the RO system 104, such that it may be possible to slide the separator 116 through an entire length of the permeate tube 114. The cable 402 may be a thread or a rope that may allow easy movement and adjustment of the separator 116 throughout the length of the permeate tube 114. The cable 402 attachment may ensure that the separator 116 remains securely in a place, preventing any accidental movement or shifting that may disrupt the operation of the RO system 104. The cable 402 may be substituted by a wire to reduce drag.

Each of the set of flowmeters 404 may be installed on the permeate tube 114 to measure the flowrate of at least one of the permeate flows through the permeate tube 114, or the feed water provided to the RO system 104. For example, the first flowmeter 404A may be installed in the RO system 104 to measure the flowrate of the feedwater. Furthermore, the second flowmeter 404B may be configured to measure the flowrate of permeate generated by the RO system 104. In an embodiment, each of the set of flowmeters 404 may be installed either inside or outside the permeate tube 114. Examples of different types of flowmeters may include, but are not limited to, an electromagnetic flowmeter, a differential pressure flowmeter, an ultrasonic flowmeter, and a rotor-based flowmeter.

The bypass tube 406 may correspond to a system of pipes, pumps, hoses, and valves that may be used to stabilize the pressure of the isolated permeate within the permeate tube 114. The bypass tube 406 may be connected to the first outlet 408A and the second outlet 408B may be utilized by the RO system 104 to stabilize pressure of the isolated permeate. As shown, the permeate tube 114 may also include the first outlet 408A and the second outlet 408B for discharging the permeate collected through the set of membranes 110. In an embodiment, the bypass tube 406 may be added to the RO system 104 to prevent a reverse flow of permeate collected in the permeate tube 114 through the set of membranes 110 in cases where the isolated permeate may have higher pressure (that may have occurred based on isolation of the permeate by the separator 116) compared to the feed water and/or the brine in the pressure vessel 112. The bypass tube 406 may be required for equalizing the permeate pressure.

In an embodiment, the RO system 104 may further include the set of electromechanical devices 410 on both the left side and the right side of the set of membranes 110. For example, the first electromechanical device 410A may be attached to the permeate tube 114 on the left side and the second electromechanical device 410B may be attached to the permeate tube 114 on the right side, as shown in the FIG. 4A. The set of electromechanical devices 410 may be tied to the cable 402 (or wire/thread) that may be used to control the movement of the separator 116 to instate the separator 116 at any position within the permeate tube 114 (e.g., the first position 414). In an exemplary scenario, the set of electromechanical devices 410 may include a motor that may be used to wind a rope (e.g., the cable 402). For example, the motor may be a kind of a winch motor. The winch motor may be designed to provide a necessary torque and a power to wind the rope or cable 402, ensuring a smooth and efficient operation of the movement of the separator 116. Although it is shown the set of electromechanical devices 410 are shown embedded within the RO system 104, the disclosure may not be limited to such implementation only. In some embodiments, the set of electromechanical devices 410 may be outside of RO system 104 and may be coupled with the RO system 104.

In another embodiment, the set of stop check valves 412 may also be installed to prevent a reverse flow of the permeate in the corresponding membrane. The reverse flow of permeate may happen due to a variety of reasons such as, but are not limited to, an excessive fouling/scaling of the Nth membrane 110N, apart from the maintenance capability. In some embodiments, the set of flowmeters 404, the set of electromechanical devices 410, and all other moving parts in the proposed solution may then be connected to the digital control and monitoring system (DCMS) and/or control system 102 associated with the RO system 104, in a manner that the one or more operators in the RO system 104 may be able to access the information obtained, monitor, and also actively control a mechanism of monitoring of membrane performance of the set of membranes 110 if needed. In an embodiment, the control system 102 (or the RO system 104) may be configured to actively control the mechanism based on the obtained information.

The set of stop check valves 412 (e.g., the first stop check valve 412A and the second stop check valve 412B) associated with the permeate tube 114 may be utilized to break the flow of the permeate flowing in the permeate tube 114. In another embodiment, the set of stop check valves 412 installed in the permeate tube 114 may be utilized to make the flow of the permeate in one of the set of outlets 408. In an exemplary scenario, the set of stop check valves 412 may be operated online and/or manually to block the flow of the permeate out of the RO system 104. Further, the RO system 104 may also include the permeate tube 114 for collecting the permeate. The feed water may be pressurized at a certain pressure through the set of membranes 110 in the pressure vessel 112 to generate the permeate after passing through the set of membranes 110 by separating salts and other impurities (e.g., biological contaminants or the like) along with the brine from the feed water. The permeate may be collected in the permeate tube 114 from the feed water after passing through the set of membranes 110.

In an embodiment, the separator 116 may correspond to at least one of a disk, a plug, or a sponge ball. The separator 116 may be made of at least one of a permeable material, a semi-permeable, and an impermeable material. In an exemplary scenario, the separator 116 may be made in the form of a disc, a cylinder, and/or a spherical ball from either the permeable material (e.g., a material that lets permeate pass through it), the semi-permeable membrane that exhibits a moderate level of permeability such that certain molecules can pass through while impeding the passage of the salts and the biofouling depending upon their size. However, the separator 116 made of impermeable material may not allow any material or the molecule of the material (e.g., a liquid such as water) to pass through. The impermeable material acts as a barrier for the permeate by effectively blocking the flow of the permeate by isolating the permeate into a left-side portion and a right-side portion of the permeate tube 114 with respect to the position of the separator 116 instated inside the permeate tube 114.

In some embodiments, the RO system 104 may also include a set of control valves (not shown in figures) embedded within the pressure vessel 112. Further, at least one of the set of control valves may be utilized to intake or discharge at least one of the feed water or the brine. For example, the set of control valves may function to stop the flow of either the feed water or brine, similar to the set of stop check valves 412 used to stop the flow of the permeate.

In an embodiment, the movement controlling module 302A of the processor 302 may be configured to control the first movement of the separator 116 embedded in the permeate tube 114 from an initial position to the first position 414 within the permeate tube 114. The first position 414 may be between the first membrane 110A and the second membrane 110B of the set of membranes 110. The processor 302 may be further configured to determine a first flowrate of the permeate flowing through a first membrane 110A of the set of membranes 110 based on the first movement of the separator 116. In an embodiment, the processor 302 may be configured to determine the first flowrate using the set of flowmeters 404. The processor 302 may be further configured to calculate a first flux for the first membrane 110A based on the determined first flowrate of the permeate and a first surface area of the first membrane 110A. In an embodiment, the flux calculation module 302B of the processor 302 may be configured to calculate the first flux for the first membrane 110A based on the determined first flowrate of the permeate and the first surface area of the first membrane 110A.

Based on the calculation of the first flux, the processor 302 may be configured to render the calculated first flux on the display screen 106. In an embodiment, the display controlling module 302C of the processor 302 may be configured to render the calculated first flux on the display screen 106. In an embodiment, the processor 302 may be further configured to calculate the first brine flow rate, the first recovery rate, and the first brine-to-permeate ratio associated with the first membrane 110A based on at least one of the calculated first flux or the determined first flowrate. In an embodiment, the display controlling module 302C of the processor 302 may be configured to render the calculated first brine flowrate, the first recovery rate, and the first brine-to-permeate ratio associated with the first membrane 110A on the display screen 106. Based on the calculation of the first flux, the processor 302 may be configured to control a second movement of the separator 116. Details about the second movement are provided, for example, in FIG. 4B.

FIG. 4B illustrates a schematic diagram 400B depicting a second position of the separator 116 within the RO system, in accordance with an embodiment of the present disclosure. FIG. 4B is explained in conjunction with elements from FIG. 1, FIG. 2, FIG. 3, and FIG. 4A. With reference to FIG. 4B, there is shown the RO system 104 of FIG. 1. There is further shown a second position 418 of the separator 116.

In an embodiment, the movement controlling module 302A of the processor 302 may be configured to control a second movement of the separator 116 from the first position 414 to the second position 418 within the permeate tube 114 after the calculation of the first flux. Similar to the first position 414, the second position 418 may be between the second membrane 110B, and the Nth membrane 110N of the set of membranes 110. For example, the separator 116 may be instated at the second position 418 for determining a second flux for the second membrane 110B. Based on the second movement of the separator 116, the processor 302 may be configured to determine a first collective flowrate of the permeate. The first collective flowrate may correspond to a combined flowrate from the first membrane 110A and the second membrane 110B of the set of membranes 110.

After the second movement of the separator 116, the first membrane 110A and the second membrane 110B may be on the left side of the separator 116 and the Nth membrane 110N may be on the right side of the separator 116. In this way, the flowrate of the permeate flowing through the first outlet 408A may be measured to determine the first collective flowrate. As discussed above, the first collective flowrate may include the first flowrate of the first membrane 110A and a second flowrate of the second membrane 110B. Furthermore, the processor 302 may be further configured to render the first collective flowrate on the display screen 106. The first collective flowrate may be indicative of a flowrate that includes a combination of the first flowrate from the first membrane 110A and the second flowrate from the second membrane 110B.

The processor 302 may be further configured to determine a second flowrate of the permeate flowing through the second membrane 110B. The second flowrate may be determined based on the determined first collective flowrate, and the determined first flowrate. Specifically, the second flowrate may be determined by subtracting the first flowrate from the first collective flowrate. The processor 302 may be further configured to determine a second surface area of the second membrane 110B of the set of membranes 110. Based on the determined second flowrate and the second surface area, the processor 302 may be configured to calculate the second flux for the second membrane 110B of the set of membranes 110. The processor 302 may be further configured to render the calculated second flux on the display screen 106.

Similar to the calculation of the first flux and the second flux, the processor 302 may be configured to calculate the individual flux for each membrane within the RO system 104 based on the movement of the separator 116 along the permeate tube 114. Specifically, the processor 302 may be configured to iteratively repeat the process for each membrane until the separator 116 is placed at the end of the Nth membrane 110N. At this point, the control system 102 may calculate the permeate product flowrate of the entire permeate tube 114, and with this information, the control system 102 may be able to calculate the brine flowrate in each membrane and calculate the flux for each membrane and an average flux for each of the set of membranes 110. In an embodiment, the average flux of the RO system 104 may be calculated by summing the fluxes of each membrane of the set of membranes 110 and dividing the sum by the number of membranes present in the set of membranes 110. For example, if the sum of the fluxes of each of the membranes is ‘X’ then the average flux may be determined by dividing X by N (here N is the number of membranes present in the set of membranes 110).

In an embodiment, the RO system 104 may include multiple pressure vessels (similar to the pressure vessel 112) and each pressure vessel may include multiple membranes. In such a scenario, the movement controlling module 302A of the processor 302 may be configured to control a third movement of the separator 116 from the second position 418 to a third position (not shown in figures) within the permeate tube 114 in order to calculate a second collective flowrate from the first membrane 110A, the second membrane 110B, and the Nth membrane 110N. In an embodiment, the third position may be at the end of the Nth membrane 110N of the set of membranes 110. Further, the flowrate of the permeate collected through the the first membrane 110A, the second membrane 110B, and the Nth membrane 110N may be measured using the set of flowmeters 404. The first collective flowrate may be subtracted from the second collective flowrate to determine the third flowrate of the permeate associated with the Nth membrane 110N. The determined third flowrate may be then utilized to further calculate an Nth flux for the Nth membrane 110N. The Nth flux may be calculated based on the third flowrate and a third surface area of the Nth membrane 110N of the set of membranes 110. Further, the above process for calculating the flowrate may be repeated for any number of membranes in the pressure vessel 112.

In some embodiments, the processor 302 may be configured to calculate at least one of the recovery rate, the brine flowrate, and the brine-to-permeate ratio of the RO system 104 based on the calculated individual fluxes of each membrane in the RO system 104. The recovery rate may be calculated by dividing an amount of permeate produced by the RO system 104 by an amount of the feed water that enters the RO system 104, and then multiplying by 100. The calculation of the recovery rate may provide a percentage value that may represent an efficiency of the RO system 104 in converting the feed water into the permeate. In an embodiment, the brine flowrate may be calculated by utilizing the set of flowmeters 404. In another embodiment, the brine-to-permeate ratio of the RO system 104 may calculated by dividing a volume of the brine produced by the RO system 104 by a volume of the permeate generated by the RO system 104 in a certain amount of time.

In an embodiment, the processor 302 may be further configured to render at least one of the recovery rate, the brine flowrate, or the brine-to-permeate ratio associated with the RO system 104 on the display screen 106. The at least one of the recovery rate, the brine flowrate, or the brine-to-permeate ratio may be rendered on the display screen 106 to notify or present information about the performance of the set of membranes 110 to the one or more operators.

In an embodiment, the set of sensors 118 may be embedded within the RO system 104. In an embodiment, the set of sensors 118 may be embedded within the separator 116. In another embodiment, the set of sensors 118 may be embedded within the permeate tube 114 or the pressure vessel 112. In another embodiment, the set of sensors 118 may be embedded within at least one membrane of the set of membranes 110.

The set of sensors 118 may include at least one of a temperature sensor (e.g., a thermometer), a potential of hydrogen (pH) sensor, an alkalinity sensor, a hardness sensor, an oxidation-reduction potential (ORP) sensor, a pressure sensor, a conductivity sensor. The processor 302 may be configured to control the set of sensors 118 to capture a set of parameters associated with the permeate collected and/or flowing in the permeate tube 114. The one or more parameters may include at least one of a temperature captured by the temperature sensor, a pH captured by the pH sensor, a salinity captured by the conductivity sensor, a hardness conductivity sensor by the hardness sensor, a conductivity sensor measured by the alkalinity sensor, a pressure conductivity sensor by the pressure sensor, and an amount of chemicals associated with the permeate flowing through the first membrane 110A of the set of membranes 110. Further, in some embodiments, the set of sensors 118 may also be used to measure the corresponding one or more physical and/or chemical parameters associated with each membrane of the set of membranes 110. To this end, the set of sensors 118 may collect data and transmit the collected data to the RO system 104. The processor 302 of the RO system 104 may further render the captured set of parameters on the display screen 106.

FIG. 5 is a diagram that illustrates exemplary operations for monitoring membrane performance of the reverse osmosis system, in accordance with an embodiment of the present disclosure. FIG. 5 is explained in conjunction with elements from FIG. 1, FIG. 2, FIG. 3, FIG. 4A, and FIG. 4B. With reference to FIG. 5, there is shown a block diagram 500 that illustrates exemplary operations from 502A to 502H, as described herein. The exemplary operations illustrated in the block diagram 500 may start at 502A and may be performed by any computing system, apparatus, or device, such as by the control system 102 of FIG. 1 or the processor 202 of FIG. 2. Although illustrated with discrete blocks, the exemplary operations associated with one or more blocks of the block diagram 500 may be divided into additional blocks, combined into fewer blocks, or eliminated, depending on the particular implementation.

At 502A, a threshold determination operation may be performed. In the threshold determination operation, the control system 102 may be configured to determine that at least one of the average flux of the RO system 104 is lower than the minimum flux threshold or greater than the maximum flux threshold, the average brine flowrate of the RO system 104 is lower than the minimum brine flowrate threshold or greater than the maximum brine flowrate threshold, the average recovery rate of the RO system is lower than the minimum recovery rate threshold or greater than the maximum recovery rate threshold, or the average brine-to-permeate ratio of the RO system is greater than the minimum brine-to-permeate ratio threshold or less than the maximum brine-to-permeate threshold. Details about the flux, the brine flowrate, the recovery rate, and the brine-to-permeate ratio are provided, for example, in FIG. 1.

At 502B, a first movement control operation may be performed. In the first movement control operation, the control system 102 may be configured to control the first movement of the separator 116 from the initial position to the first position 414 within the permeate tube 114. The separator 116 may be embedded within the permeate tube 114 of the RO system 104. In an embodiment, the movement controlling module 202A of the processor 202 may be configured to control the first movement of the separator 116. The first position 414 may be between the first membrane 110A and the second membrane 110B of the set of membranes 110. In an embodiment, the first movement may be made to instate the separator 116 at the first position in the permeate tube 114 from the initial position of the separator 116 within the permeate tube 114. The initial position may be a position in the permeate tube 114 where the separator 116 is instated initially (e.g., before the start of monitoring of membrane performance of a membrane of the set of membranes 110). In an embodiment, the first position 414 may be any position or location in the permeate tube 114. For an instance, the first position may be a position between any two consecutive membranes of the set of membranes 110 (e.g., the first membrane 110A and the second membrane 110B). Details about the first movement of separator 116 are provided, for example, in FIG. 1, and FIG. 4A.

At 502C, a first flowrate determination operation may be performed. In the first flowrate operation, the control system 102 may be configured to determine the first flowrate of the permeate flowing through the first membrane 110A of the set of membranes 110 based on the first movement of the separator 116. After the first movement of the separator 116 from the initial position to the first position 414, the permeate collected in the permeate tube 114 may be separated such that the permeate collected after passing through the first membrane 110A (referred to as, a first amount of the permeate) may be isolated from the permeate collected after passing through remaining membranes (one or more membranes except the first membrane 110A) of the set of membranes 110. In an embodiment, the flow of the first amount of the permeate may be measured using a flowmeter installed within the permeate tube 114 to determine the first flowrate. The first flowrate may be defined as a rate of flow of the permeate form the first membrane 110A and may be expressed in terms of volume per unit time, such as litres per hour or cubic meters per second. The first flowrate of the first membrane 110A may depend on various factors, including the pressure difference across the first membrane 110A, the first surface area of the first membrane 110A, and properties of the feed water being filtered (e.g., salt level or the like). The determined first flowrate may be further utilized for calculating the first flux for the first membrane 110A, as explained in the following paragraphs. Details about the first flowrate are provided, for example, in FIG. 1, and FIG. 4A.

At 502D, a first flux calculation operation may be performed. In the first flux calculation operation, the control system 102 may be configured to calculate the first flux for the first membrane 110A based on the determined first flowrate of the permeate and the first surface area of the first membrane 110A. In an embodiment, the flux calculation module 202B of the processor 202 may be configured to calculate the first flux. The first flux may be expressed in terms of gallons per square foot per day (GFD) and/or litres per square meter per hour. Details about the calculation of the flux are provided, for example, in FIG. 4A and FIG. 4B.

At 502E, a second movement control operation may be performed. In the second movement control operation, the control system 102 may be configured to control the second movement of the separator 116 from the first position 414 to the second position 418 within the permeate tube 114. In an embodiment, the movement controlling module 202A of the processor 202 may be configured to control the second movement of the separator 116 from the first position 414 to the second position 418 within the permeate tube 114 after the calculation of the first flux. The second position may be between the second membrane 110B and the Nth membrane 110N of the set of membranes 110. Details about the second movement of separator 116 are provided, for example, in FIG. 4B.

At 502F, a second flowrate determination operation may be performed. In the second flowrate determination operation, the control system 102 may be configured to determine the second flowrate of the permeate flowing through the second membrane 110B. To determine the second flowrate, the control system 102 may be further configured to determine a first collective flowrate of the permeate from the first membrane 110A and the second membrane 110B based on the second movement of the separator 116. The control system 102 may be configured to determine the second flowrate of the permeate flowing through the second membrane 110B based on the determined first collective flowrate, and the determined first flowrate. Specifically, the second flowrate may be determined by subtracting the first flowrate from the first collective flowrate. Details about the determination of the second flowrate are provided, for example, in FIG. 4B.

At 502G, a second flux calculation operation may be performed. In the second flux calculation operation, the flux calculation module 202B of the processor 202 may be configured to calculate the second flux for the second membrane 110B. To calculate the second flux, the processor 202 may be configured to determine a second surface area of the second membrane 110B of the set of membranes 110. The flux calculation module 202B of the processor 202 may be configured to calculate the second flux for the second membrane 110B of the set of membranes 110 based on the determined second flowrate, and the determined second surface area. Details about the calculation of the second flux are provided, for example, in FIG. 4B.

At 502H, a flux rendering operation may be performed. In the flux rendering operation, the control system 102 may further render the calculated first flux and the calculated second flux on the display screen 106. In an embodiment, the display controlling module 202C of the processor 202 may be configured to display the calculated first flux and the calculated second flux on the display screen 106. Details about the rendering of the calculated first flux and the second flux are provided, for example, in FIG. 6.

In an alternate embodiment, the control system 102 may be configured to calculate the first set of metrics associated with the permeate flowing through the first membrane. The first set of metrics includes at least one of the first permeate flowrate, the first brine flowrate, the first feedwater flowrate, or the first electrical conductivity of the permeate flowing through the first membrane based on the captured set of parameters. The control system 102 may be further configured to render at least one of the first set of metrics of the RO system 104 on the display screen 106.

In an alternate embodiment, the control system 102 may be further configured to calculate the second set of metrics associated with the permeate flowing through the second membrane. The second set of metrics includes at least one of the second permeate flowrate, the second recovery rate, the second brine flowrate, the second feedwater flowrate, the second brine-to-permeate ratio, or the second electrical conductivity of the permeate based on at least one of the calculated first set of metrics and the captured first set of parameters. The control system 102 may be further configured to render at least one of the second set of metrics of the RO system 104 on the display screen 106. Similarly, the control system 102 may be further configured to calculate the n^{th} set of metrics associated with the permeate flowing through the n^{th} membrane based on at least one of the calculated n−1 set of metrics and the captured set of parameters. The control system 102 may be further configured to render at least one of the n^{th} set of metrics of the RO system 104 on the display screen 106.

In an embodiment, the control system 102 may be configured to calculate the set of metrics associated with the permeate flowing through multiple membranes in batches based on the position of the flowmeters. Specifically, the control system 1-2 may be configured to measure membrane performance by reading from the front of the pressure vessel as well as from the back, depending on if the flow meter for permeate outlet is placed at the front or rear end of the permeate tube 114.

In yet another embodiment, the control system 102 may be configured to determine, based on the calculated first flux for the first membrane 110A, one or more suggestions for maintaining at least one of the average flux of the RO system 104 between the minimum threshold and the maximum flux threshold, the average brine flowrate of the RO system 104 between the minimum brine flowrate threshold and the maximum brine flowrate, the average permeate flowrate of the RO system 104 between the minimum permeate flowrate threshold and the maximum permeate flowrate threshold, the average recovery rate of the RO system 104 between the minimum recovery rate threshold and the maximum recovery rate threshold, or the average brine-to-permeate ratio between the minimum brine-to-permeate ratio threshold and the maximum brine-to-permeate threshold. The one or more suggestions may be associated with the set of membranes 110 of the RO system 104. The control system 102 may be further configured to render the determined one or more suggestions on the display screen 106. Details about the one or more suggestions are provided, for example, in FIG. 4B and FIG. 6.

In another embodiment, the control system 102 may be configured to control the set of sensors 118 to capture the set of parameters associated with the permeate flowing through at least the first membrane 110A of the set of membranes 110. The set of sensors may be embedded within at least one of the separator 116 or the permeate tube 114 of the RO system 104. The control system 102 may be further configured to render the captured set of parameters on the display screen 106. The captured set of parameters may include at least one of a temperature, a potential of hydrogen (pH), a salinity, an alkalinity, a hardness, a pressure, and an amount of chemicals associated with the permeate flowing through the first membrane 110A of the set of membranes 110. Details about the set of sensors 118 are provided, for example, in FIG. 4B.

FIG. 6 illustrates a schematic diagram 600 of the display screen 106 utilized for rendering the calculated flux, in accordance with an embodiment of the present disclosure. FIG. 6 is explained in conjunction with elements from FIGS. 1, 2, 3, 4A, 4B and 5. With reference to FIG. 6, there is shown the display screen 106 and a set of flux user interface (UI) elements 602, an average flux UI element 604, and a suggestion UI element 606 displayed on the UI of the display screen 106. The set of flux UI elements 602 may include a first UI element 602A, a second UI element 602B, and an Nth UI element 602N.

Each of the set of flux UI elements 602 may be, for example, a textbox and may display the calculated individual flux of each membrane of the set of membranes 110 of the RO system 104. For example, the first UI element 602A may render the calculated first flux of the first membrane 110A, and the second UI element 602B may render the calculated second flux of the second membrane 110B. Similarly, the Nth UI element 602N may render Nth flux of the Nth membrane 110N of the RO system 104. The average flux UI element 604 may be a textbox and may display the calculated average flux of the RO system 104. Details about the calculation of the average flux are provided, for example, in FIGS. 4A and 4B.

In some embodiments, the control system 102 (or the RO system 104) may be configured to determine the one or more suggestions for maintaining at least one of the average flux of the RO system 104 between the minimum threshold and the maximum flux threshold, the average brine flowrate of the RO system 104 between the minimum brine flowrate threshold and the maximum brine flowrate, the average permeate flowrate of the RO system 104 between the minimum permeate flowrate threshold and the maximum permeate threshold, the average recovery rate of the RO system 104 between the minimum recovery rate threshold and the maximum recovery rate threshold, or the average brine-to-permeate ratio between the minimum brine-to-permeate ratio threshold and the maximum brine-to-permeate threshold. The control system 102 (or the RO system 104) may be configured to render the determined one or more suggestions on the display screen 106. Specifically, the determined one or more suggestions may be displayed within the suggestion UI element 606.

In some other embodiments, the control system 102 (or the RO system 104) may be configured to calculate at least one of the recovery rate, the brine flowrate, the brine-to-permeate ratio of the RO system 104 based on the calculated first flux and the calculated second flux and render at least one of the recovery rate, the brine flowrate, or the brine-to-permeate ratio of the RO system 104 on the display screen 106.

In another embodiment, the control system 102 (or the RO system 104) may be configured to control the set of sensors 118 to capture the set of parameters associated with the permeate flowing through at least the first membrane 110A of the set of membranes 110. The control system 102 (or the RO system 104) may be configured to render the captured set of parameters on the display screen 106. The captured set of parameters may include at least one of a temperature, a pH, a salinity, an alkalinity, a hardness, a pressure, and an amount of chemicals associated with the permeate flowing through the first membrane 110A of the set of membranes 110. The displayed set of parameters may be analyzed, by the operator of the RO system 104, to make decisions related to the replacement or cleaning of the set of membranes 110. In some embodiments, the displayed set of parameters may act as an evidence, to support the one or more suggestions displayed in the suggestion UI element 606.

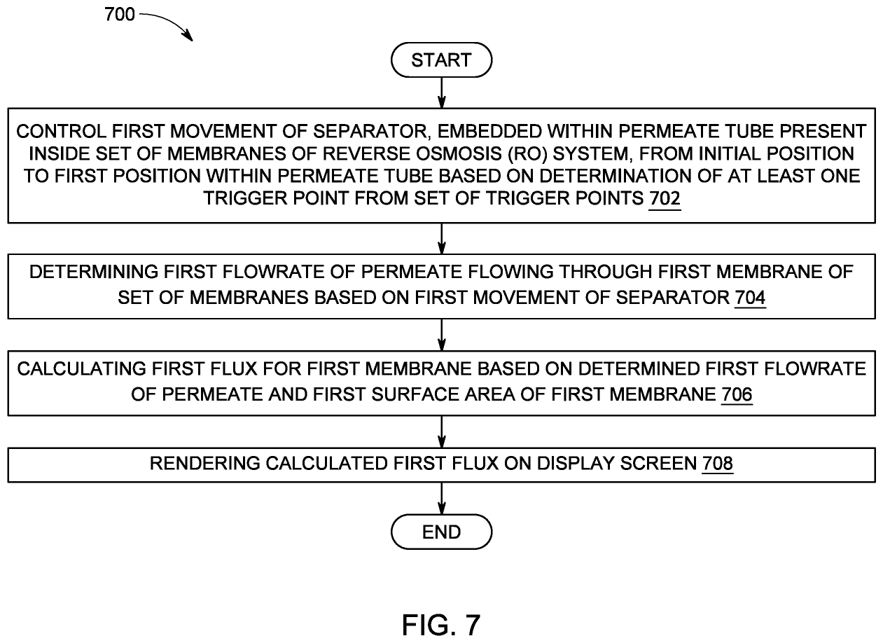

FIG. 7 illustrates a flowchart 700 of a method implemented by the control system 102 for monitoring membrane performance of the RO system, in accordance with an embodiment of the present disclosure. FIG. 7 is explained in conjunction with elements from FIGS. 1, 2, 3, 4A, 4B, and 5. With reference to FIG. 7, there is shown the flowchart 700. The operations of the exemplary method may be executed by any computing system, for example, by the control system 102 of FIG. 1 or the processor 202 of FIG. 2. The operations of the flowchart 700 may start at and proceed to 702.

At 702, the first movement of the separator 116 embedded in permeate tube 114 of RO system 104 may be controlled. The first movement of the separator 116 may be controlled from the initial position to the first position 414 within the permeate tube 114 of the RO system 104. The first movement of the separator 116 may be controlled based on the determination that at least one of the trigger points from the set of trigger points. The set of trigger points are associated with the average flux of the RO system 104 or any membrane of the set of membranes 110 on the pressure vessel 112 is lower than a minimum flux threshold or greater than a maximum flux threshold, the average brine flowrate of the RO system 104 or any membrane of the set of membranes 110 on the pressure vessel 112 is lower than a minimum brine flowrate threshold or greater than a maximum brine flowrate threshold, the average permeate flowrate of the RO system 104 or any membrane of the set of membranes 110 on the pressure vessel 112 is less than a minimum permeate flowrate threshold or permeate than a maximum permeate flowrate threshold, the average recovery rate of the RO system 104 or any membrane of the set of membranes 110 on the pressure vessel 112 is lower than a minimum recovery rate threshold or greater than a maximum recovery rate threshold, or the average brine-to-permeate ratio of the RO system 104 or any membrane of the set of membranes 110 on the pressure vessel 112 is lower than a minimum brine-to-permeate ratio threshold or greater than a maximum brine-to-permeate threshold. The set of trigger point may further be associated with the change in the temperature of the feedwater, or the change in the electrical conductivity of the feedwater, or the change in the pH of the feedwater, or the change in the permeate flowrate produced by the RO system 104 or of any individual membrane of the set of membranes 110 on the pressure vessel 112, or change in the electrical conductivity of the permeate produced by the RO system 104 or of any individual membrane of the set of membranes 110 on the pressure vessel 112, or the change in the pH of the permeate produced by the RO system or of any individual membrane of the set of membrane 110 on the pressure vessel 112, or the change in the concentration of at least one ion present in the permeate produced by the RO system or of any individual membrane of the set of membranes 110 on the pressure vessel 112, or a change in a feedwater pressure required to operate the RO system 104, or a change in a pressure differential between feedwater an inlet and an outlet on the RO system or any individual pressure vessel 112. In at least one embodiment, the processor 202 may control the first movement of the separator 116, embedded within the permeate tube 114 of the RO system 104, from the initial position to the first position 414 within the permeate tube 114 based on the determination of the trigger point from the set of trigger points. Details about the first movement are provided, for example, in FIG. 1.

At 704, the first flowrate of the permeate flowing through the first membrane 110A of the set of membranes 110 may be determined. The first flowrate may be determined based on the first movement of the separator 116. In at least one embodiment, the processor 202 may determine the first flowrate of the permeate flowing through the first membrane 110A of the set of membranes 110 based on the first movement of the separator 116. Details about the determination of the first flowrate are provided, for example, in FIG. 1.

At 706, the first flux for the first membrane 110A of the set of membranes 110 may be calculated. The first flux is calculated based on the first flowrate of the permeate through the first membrane 110A and the first surface area of the first membrane 110A. In at least one embodiment, the processor 202 may calculate the first flux for the first membrane 110A based on the determined first flowrate of the permeate and a first surface area of the first membrane 110A. Details about the calculation of the first flux are provided, for example, in FIG. 1.

At 708, the calculated first flux may be rendered on the display screen 106. In at least one embodiment, the processor 202 may render the calculated first flux for the first membrane 110A. Details about the rendering of the first flux are provided, for example, in FIG. 1 and FIG. 6.

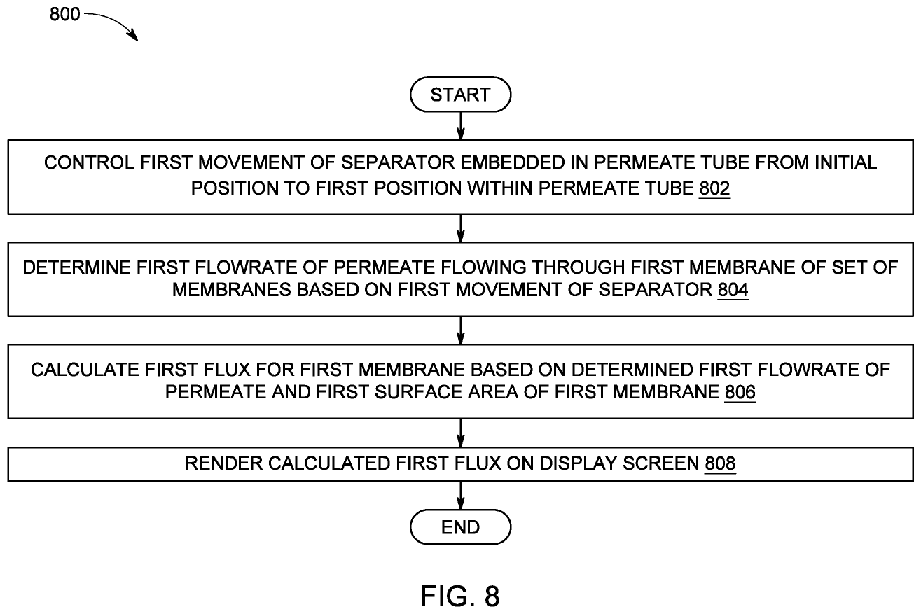

FIG. 8 illustrates a flowchart 800 of a method implemented by the RO system 104 for monitoring membrane performance of the RO system, in accordance with an embodiment of the present disclosure. FIG. 8 is explained in conjunction with elements from FIGS. 1, 2, 3, 4A, 4B, 5, and 6. With reference to FIG. 8, there is shown a flowchart 800. The operations of the exemplary method may be executed by any computing system, for example, by the RO system 104 of FIG. 1 or the processor 302 of FIG. 3. The operations of the flowchart 800 may start at and proceed to 802.

At 802, the first movement of separator 116 embedded in the permeate tube 114 may be controlled. The first movement may be controlled from the initial position to the first position 414 within the permeate tube 114. In at least one embodiment, the processor 302 may control the first movement of the separator 116, embedded within the permeate tube 114 of the RO system 104, from the initial position to the first position 414 within the permeate tube 114. Details about the first movement are provided, for example, in FIG. 4A.

At 804, the first flowrate of the permeate flowing through the first membrane 110A of the set of membranes 110 may be determined. The first flowrate may be determined based on the first movement of the separator 116. The first flowrate may be calculated to determine the first flux associated with the first membrane 110A. The determined first flux may also be utilized to determine the performance of the first membrane 110A. In at least one embodiment, the processor 202 may determine the first flowrate of the permeate flowing through the first membrane 110A of the set of membranes 110 based on the first movement of the separator 116. Details about the determination of the first flowrate are provided, for example, in FIGS. 4A, and 4B.

At 806, the first flux for the first membrane 110A of the set of membranes 110 may be calculated. The first flux is calculated based on the first flowrate of the permeate through the first membrane 110A and the first surface area of the first membrane 110A. In at least one embodiment, the processor 302 may calculate the first flux for the first membrane 110A based on the determined first flowrate of the permeate and a first surface area of the first membrane 110A. Details about the calculation of the first flux are provided, for example, in FIGS. 4A, and 4B.

At 808, the calculated first flux may be rendered on the display screen 106. the calculated first flux may be rendered on the display screen 106. In at least one embodiment, the processor 202 may render the calculated first flux for the first membrane 110A. Details about the rendering of the first flux are provided, for example, in FIG. 4A, FIG. 4B, and FIG. 6

Accordingly, blocks of the flowchart 700 and 800 support combinations of means for performing the specified functions and combinations of operations for performing the specified functions. It will also be understood that one or more blocks of the flowchart 700 and 800, and combinations of blocks in the flowchart 700 and 800, can be implemented by special purpose hardware-based computer systems which perform the specified functions, or combinations of special purpose hardware and computer instructions.

Alternatively, the control system 102 and the RO system 104 may comprise means for performing each of the operations described above. In this regard, according to an example embodiment, examples of means for performing operations may comprise, for example, the processor and/or a device or circuit for executing instructions or executing an algorithm for processing information as described above.

It may be noted that the above disclosure is explained in terms of the control system 102 and the RO system 104 of the SWRO plants. However, the disclosure is not limited to SWRO plants only. The disclosed invention may be directly applicable to BWRO plants as well. The disclosed invention may be applicable to other industries that use membranes such as the wastewater management industry, food industry, and pharmaceutical industries at least.

In some embodiments, a part load operation of the RO system 104 may also be something that this disclosed invention may aid, because under these conditions of the spare capacity that is available, the fluxes may be reduced considerably below the design point (e.g., the maximum flux threshold), and potential energy savings may be achieved. The part load operation may refer to an operation of the RO system 104, at less than its maximum capacity or design point. It occurs when a demand or a load on the RO system 104 is lower than its full capacity. During the part load operation, the RO system 104 may be adjusted to run at a lower flux rate to match a current demand for the freshwater or the permeate due to a lower flowrate of the feed water or a decreased need for the freshwater. The disclosure may also aid in optimizing the performance of the RO system 104 during the part load operation such that when the RO system 104 operates at a reduced capacity.

Various embodiments of the disclosure may provide a non-transitory computer readable medium and/or storage medium having stored thereon, instructions executable by a machine and/or a computer to operate a control system (e.g., the control system 102) for monitoring membrane performance of reverse osmosis systems. The instructions may cause the machine and/or computer to perform operations that include controlling a first movement of a separator (e.g., the separator 116), embedded within a permeate tube (e.g., the permeate tube 114) of a reverse osmosis (RO) system (e.g., the RO system 104), from an initial position to a first position (e.g., the first position 414) within the permeate tube based on a determination of at least one of trigger point from a set of trigger points. The operations further include determining a first flowrate of a permeate flowing through a first membrane (e.g., the first membrane 110A) of a set of membranes (e.g., the set of membranes 110) based on the first movement of the separator. The operations further include calculating a first flux for the first membrane based on the determined first flowrate of the permeate and a first surface area of the first membrane. The operations further include rendering the calculated first flux on a display screen (e.g., the display screen 106).

Various embodiments of the disclosure may provide a non-transitory computer-readable medium and/or storage medium having stored thereon, instructions executable by a machine and/or a computer to operate a reverse osmosis system (e.g., the RO system 104) for monitoring membrane performance of reverse osmosis systems. The instructions may cause the machine and/or computer to perform operations that include controlling a first movement of a separator (e.g., the separator 116) embedded in the permeate tube (e.g., the permeate tube 114) from an initial position to a first position (e.g., the first position 414) within the permeate tube. The operations further include determining a first flowrate of the permeate flowing through a first membrane (e.g., the first membrane 110A) of a set of membranes (e.g., the set of membranes 110) based on the first movement of the separator. The operations further include calculating a first flux for the first membrane based on the determined first flowrate of the permeate and a first surface area of the first membrane. The operations further include rendering the calculated first flux on a display screen (e.g., the display screen 106).

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed:

1. A control system, comprising:
at least one non-transitory memory configured to store computer-executable instructions; and
at least one processor configured to execute the computer-executable instructions to:
control a first movement of a separator, embedded within a permeate tube present inside a set of membranes of a reverse osmosis (RO) system, from an initial position to a first position within the permeate tube based on a determination of at least one of a trigger point from a set of trigger points;
determine a first flowrate of a permeate flowing through a first membrane of the set of membranes based on the first movement of the separator;
calculate a first flux for the first membrane based on the determined first flowrate of the permeate and a first surface area of the first membrane; and
render the calculated first flux on a display screen.

2. The control system of claim 1, wherein the set of trigger points are associated with:
an average flux of the RO system or any membrane of the set of membranes on a pressure vessel of the RO system is greater than a maximum flux threshold or less than a minimum flux threshold, or
an average brine flowrate of the RO system or any membrane of the set of membranes on the pressure vessel is greater than a maximum brine flowrate threshold or less than a minimum brine flowrate threshold, or
an average permeate flowrate of the RO system or of any membrane of the set of membranes on the pressure vessel is greater than a maximum permeate flowrate threshold or less than a minimum permeate flowrate threshold, or
an average recovery rate of the RO system or of any membrane of the set of membranes on the pressure vessel is greater than a maximum recovery rate threshold or less than a minimum recovery rate threshold, or
an average brine-to-permeate ratio of the RO system or of the set of membranes on the pressure vessel is greater than a maximum brine-to-permeate threshold or less than a minimum brine-to-permeate threshold, or
a change in temperature of a feedwater, or
a change in an electrical conductivity of the feedwater, or
a change in a potential of hydrogen (pH) of the feedwater,
a change in a permeate flowrate produced by the RO system or of any individual membrane of the set of membranes on the pressure vessel, or
a change in the electrical conductivity of the permeate produced by the RO system or of any individual membrane of the set of membranes on the pressure vessel, or
a change in the pH of the permeate produced by the RO system or of any individual membrane of the set of membranes on the pressure vessel,
a change in a concentration of at least one ion present in the permeate produced by the RO system or of any individual membrane of the set of membranes on the pressure vessel,
a change in a feedwater pressure required to operate the RO system, or
a change in a pressure differential between feedwater an inlet and an outlet on the RO system or any individual pressure vessel.

3. The control system of claim 1, wherein the first position is between the first membrane and a second membrane of the set of membranes.

4. The control system of claim 1, wherein at least one processor is further configured to:
control a second movement of the separator from the first position to a second position within the permeate tube after the calculation of the first flux, wherein the second position is between a second membrane and a third membrane of the set of membranes;
determine a first collective flowrate of the permeate from the first membrane and the second membrane based on the second movement of the separator; and
render the determined first collective flowrate on the display screen.

5. The control system of claim 4, wherein at least one processor is further configured to:
determine a second flowrate of the permeate flowing through the second membrane based on the determined first collective flowrate, and the determined first flowrate;
calculate a second flux for the second membrane of the set of membranes based on the determined second flowrate, and a second surface area of the second membrane of the set of membranes; and
render the calculated second flux on the display screen.

6. The control system of claim 5, wherein the second flowrate is determined by subtracting the first flowrate from the first collective flowrate.

7. The control system of claim 1, wherein at least one processor is further configured to:
control a set of sensors to capture a first set of parameters associated with the permeate flowing through at least the first membrane of the set of membranes, wherein the set of sensors are embedded within at least one of the separator or the permeate tube of the RO system; and
render the captured first set of parameters on the display screen, wherein the captured first set of parameters comprises at least one of: a first temperature, a first pH, a first salinity, a first conductivity, a first alkalinity, a first hardness, a first pressure, and a first amount of chemicals associated with the permeate flowing through the first membrane of the set of membranes.

8. The control system of claim 7, wherein at least one processor is further configured to:
calculate a first set of metrics associated with the permeate flowing through the first membrane, wherein the first set of metrics includes at least one of: a first permeate flowrate, a first brine flowrate, a first feedwater flowrate, or a first electrical conductivity of the flowing through the first membrane, based on the captured set of parameters; and
render at least one of the first set of metrics on the display screen.

9. The control system of claim 8, wherein at least one processor is further configured to:
calculate a second set of metrics, wherein the second set of metrics includes at least one of: a second recovery rate, a second permeate flowrate, a second brine flowrate, a second feedwater flowrate, a second brine-to-permeate ratio, a second electrical conductivity of the permeate or a second permeate flowrate associated with the permeate flowing through a second membrane, based on at least one of the calculated first set metrics, the captured first set of parameters, and a second set of parameters associated with the permeate flowing through the second membrane of the set of membranes; and
render at least one of the second set of metrics on the display screen.

10. The control system of claim 1, wherein at least one processor is further configured to:
determine, based on the calculated first flux for the first membrane, one or more suggestions for maintaining at least one of: an average flux of the RO system between a minimum flux threshold and a maximum flux threshold, an average brine flowrate of the RO system between a minimum brine flowrate threshold and a maximum brine flowrate, an average recovery rate of the RO system above a minimum recovery rate threshold, or an average brine-to-permeate ratio above a minimum brine-to-permeate threshold; and
render the determined one or more suggestions.

11. The control system of claim 10, wherein the determined one or more suggestions are associated with the set of membranes of the RO system.

12. A reverse osmosis (RO) system comprising:
a set of membranes;
a permeate tube present inside the set of membranes;
a separator embedded inside the permeate tube;
a bypass tube connected to a first outlet and a second outlet of the permeate tube to equalize a pressure of a permeate at a first portion of the permeate tube and a second portion of the permeate tube;
at least one non-transitory memory configured to store computer-executable instructions; and
at least one processor configured to execute the computer-executable instructions to:
controlling a first movement of the separator embedded in the permeate tube from an initial position to a first position within the permeate tube;
determining a first flowrate of the permeate flowing through a first membrane of the set of membranes based on the first movement of the separator;
calculating a first flux for the first membrane based on the determined first flowrate of the permeate and a first surface area of the first membrane; and
rendering the calculated first flux on a display screen.

13. The RO system of claim 12, wherein the RO system further comprising:
a set of pressure vessels, wherein each pressure vessel of the set of pressure vessels comprises of the set of membranes; and
a set of control valves embedded within the pressure vessel, wherein at least one of the set of control valves is utilized to intake or discharge at least one of: a feed water or a brine.

14. The RO system of claim 12, wherein the separator corresponds to at least one of: a disk, a plug, or a sponge ball.

15. The RO system of claim 12, further comprises of at least one electromechanical device, and wherein the at least one electromechanical device is configured to control a movement of the separator throughout the permeate tube.

16. The RO system of claim 12, wherein the first position is between the first membrane and a second membrane of the set of membranes.

17. The RO system of claim 12, wherein at least one processor is further configured to:
controlling a second movement of the separator from the first position to a second position within the permeate tube after the calculation of the first flux, wherein the second position is between a second membrane and a third membrane of the set of membranes;
determining a first collective flowrate of the permeate from the first membrane and the second membrane based on the second movement of the separator; and
rendering the determined first collective flowrate on the display screen.

18. The RO system of claim 12, wherein at least one processor is further configured to:
determining a second flowrate of the permeate flowing through a second membrane based on the determined first collective flowrate, and the determined first flowrate;
calculating a second flux for the second membrane of the set of membranes based on the determined second flowrate, and a second surface area of the second membrane of the set of membranes; and
rendering the calculated second flux on the display screen.

19. The RO system of claim 12, further comprises of a set of sensors, and wherein the at least one processor is further configured to:
controlling the set of sensors to capture a first set of parameters associated with the permeate flowing through the first membrane of the set of membranes, wherein the set of sensors are embedded within at least one of the separator or the permeate tube; and
rendering the captured first set of parameters on the display screen, wherein the captured first set of parameters comprises at least one of: a first temperature, a first pH, a first salinity, a first alkalinity, a first hardness, a first pressure, and a first amount of chemicals associated with the permeate flowing through the first membrane of the set of membranes.

20. A method comprising:
controlling a first movement of a separator, embedded within a permeate tube present inside a set of membranes of a reverse osmosis (RO) system, from an initial position to a first position within the permeate tube based on a determination of at least one of a trigger point from a set of trigger points;
determining a first flowrate of a permeate flowing through a first membrane of the set of membranes based on the first movement of the separator;
calculating a first flux for the first membrane based on the determined first flowrate of the permeate and a first surface area of the first membrane; and
rendering the calculated first flux on a display screen.
